(19) United States
(12) Patent Application Publication
(10) Pub. No.: US 2009/0024230 A1
(43) Pub. Date: Jan. 22, 2009

(54) PROGRAM DEVELOPMENT SUPPORT APPARATUS OF SAFETY CONTROLLER

(75) Inventors: Takehiko HIOKA, Ritto-shi (JP); Keiichi TERANISI, Numazu-shi (JP); Yoshihiro DEMURA, Kawasaki-shi (JP)

Correspondence Address: FOLEY AND LARDNER LLP;SUITE 500, 3000 K STREET NW, WASHINGTON, DC, 20007, US

(73) Assignee: OMRON CORPORATION

(21) Appl. No.: 12/136,914

(22) Filed: Jun. 11, 2008

(30) Foreign Application Priority Data
Jun. 12, 2007 (JP) P2007-154900
Jun. 13, 2007 (JP) P2007-156216
Jun. 13, 2007 (JP) P2007-156217

(51) Int. Cl. G05B 19/00

(52) U.S. Cl. 700/17

(57) ABSTRACT

The arrangement of the function block to the programming field is performed according to the guide by a function block arrangement template in which block arrangeable positions are defined vertically and horizontally and in which one end side in a row direction is defined as an input terminal side and the other end side is defined as an output terminal side; and the template is separated into an input side template positioned on an input side and including a series of plural columns respectively accepting the arrangement of a predetermined type of function block related to an input signal, and an output side template positioned on an output side and including a series of plural columns respectively accepting the arrangement of a predetermined type of function block related to an output signal.

This application claims priority from Japanese patent applications P2007-154900, filed on Jun. 12, 2007, P2007-156216, filed on Jun. 13, 2007 and P2007-156217, filed on Jun. 13, 2007. The entire contents of the aforementioned applications are incorporated herein by reference.

### BACKGROUND OF THE INVENTION

1. Field of the Invention

The present invention relates to a program development support apparatus of a safety controller in which a safety controller control program is automatically generated through a series of user operations for describing a logic circuit diagram corresponding to the desired control specification on a programming field on a screen of an image display.

2. Description of the Related Art

The safety controller incorporates a self-diagnosis function for safety aspect in addition to a logic calculation function and an input/output control function similar to a general programmable controller (PLC) to ensure high degree of safety and reliability in its control, and also has a function (fail/safe function) such that a safe control is forcibly performed so that its control does not lead to danger when abnormality is detected in the self-diagnosis result.

Safety referred to herein is, more specifically, the standardized safety standard. The safety standard includes IEC 61508 and EN standard. In the IEC 61508 (International Electro-technical Commission related to function safety of programmable electronic system), danger failure probability per hour (probability of failure per hour) is defined, and the SIL level (Safety Integrity Level) is classified into four stages according to the probability. In the EN standard, the magnitude of risk of the machine is evaluated, where it is mandatory to adopt measures to reduce the risk, and five safety categories are defined in the EN954-1. Safety controller, safety I/O terminal, and the like referred to herein correspond to one of such safety standards.

FIG. 37 shows a logic circuit diagram display example of a conventional program development support apparatus (safety network controller manufactured by Omron Co. of Japan) for creating a safety controller control program.

The program development support apparatus (first related art) is configured such that a safety controller control program is automatically generated through a series of user operations for completing a logic circuit diagram corresponding to the desired control specification by sequentially arranging one type of function block (FB81 to FB85) selected from a plurality of types of function blocks prepared in advance in a programming field 801 on a screen of an image display, and setting a necessary unique parameter (not shown) for every function block (in this example, parameter is automatically set with a drag operation by a mouse for wire drawing).

The circuit diagram data (not shown) created in correspondence to the logic circuit drawn on the programming field 801 by the user is subjected to a predetermined compile process, and converted to a setting file on which the safety controller can directly execute deciphering. The setting file for execution obtained in the above manner is installed in the target safety controller through communication or through portable recording medium.

According to the first related art, an arrangement location for function blocks and terminal displays (hereinafter referred to as circuit element) is not fixed on the programming field 801, and thus the desired circuit element can be arranged at an arbitrary position on the programming field 801, and the degree of freedom of arrangement of the circuit element is high. In order to accommodate all the desired circuit elements and arrange (lay out) such circuit elements so that the entire circuit operation can be easily understood in the programming field 801 of a limited size, certain senses and qualifications in terms of design are required, and thus may not be user-friendly to those who have poor senses and qualifications (refer to, for example, catalog of Omron Co. (available from URL http://www.fa.omron.co.jp/product/32.html)).

FIG. 38 shows a logic circuit diagram display example of another conventional program development support apparatus (manufactured from PILZ Co. of Germany) for creating the safety controller control program.

The program development support apparatus (second related art) is also configured such that a safety controller control program is automatically generated through a series of user operations for completing a logic circuit diagram corresponding to the desired control specification by sequentially arranging one type of function block (FB91 to FB95) selected from a plurality of types of function blocks prepared in advance in a programming field 901 on a screen of an image display, and setting a necessary unique parameter (not shown) for every function block (in this example, parameter is automatically set with a drag operation by a mouse for wire drawing).

In addition, in the second related art, the arrangement of the function block to the programming field 901 is carried out according to the guide by a function block arrangement template 900 displayed on the programming field 901, where a plurality of rows (R1, R2, R3, . . . ) and a plurality of columns (C1, C2, C3, . . . ) are defined with a vertical direction of the screen as a reference direction, one end (left end) in the row (R) direction is defined as an input side, the other end (right end) is defined as an output side, and a plurality of block arrangeable positions (A11 to A33) are defined in correspondence to each intersecting position of the rows (R1, R2, R3, . . . ) and the columns (C1, C2, C3, . . . ).

The circuit diagram data created in correspondence to the logic circuit drawn on the programming field 901 by the user is subjected to a predetermined compile process, and converted to a setting file on which the safety controller can directly execute deciphering, similar to the first related art. The setting file for execution thus obtained in the above manner is installed in the target safety controller through communication or through portable recording medium.

According to the second related art, since the arrangement location of the circuit element is defined in advance on the programming field 901, the desired circuit element is selected. Thereafter, when the relevant circuit element is brought close to the predefined arrangement location by the drag operation of the mouse etc., the dragged circuit element is automatically led to the predefined arrangement location. Therefore, even those who do not have sense or qualification in design of the layout can efficiently arrange a plurality of selected circuit elements in the programming field 901, and do not need to bother with the layout of the selected circuit elements as in the first related art ((refer to, for example, catalog of PILZ Co. (available from URL http://www.pilz.jp/p_saferelay7.htm)).

### SUMMARY OF THE INVENTION

In this type of program development support apparatus, the necessary function block needs to be appropriately arranged at the necessary position on the logic circuit diagram while considering not only the signal logic between input and output, but also various situations specific to the safety controller in generating the logic circuit diagram corresponding to the desired safety control specification.

For instance, when creating a logic circuit diagram so as to transmit an output signal having a predetermined logic value (stop of danger source) from one, or two or more output terminal if an input signal obtained from one, or two or more input terminals indicates a predetermined logic value (danger), the logic calculation function block corresponding to the input/output logic merely needs to be arranged between the input/output terminal columns if the logic circuit diagram is a normal controller (PLC etc.) of not the safety specification.

However, if the logic circuit diagram is the controller of the safety specification, even if an input signal indicating some kind of danger is obtained from the input terminal, the relevant input signal may be derived from failure etc. of the input equipment (safety emergency stop switch, safety light curtain, safety limit switch, safety door switch, etc.) itself detecting danger and thus such input signal cannot be immediately retrieved and provided to the necessary logic calculation. Thus, an input system function block incorporating appropriate failure diagnosis function etc. for every input equipment needs to be arranged in at least a pre-stage of the logic calculation function block (e.g., AND function block).

Even if an input signal indicating some kind of danger is obtained through such input system function block, such input signal may be derived when the worker enters a dangerous region with knowledge of the risk for adjustment and maintenance, and thus such input signal cannot be immediately retrieved and provided for the necessary logic calculation. When a predetermined condition corresponding to the time of adjustment and maintenance is satisfied, an invalidating function block having a function of invalidating the input signal may need to be arranged in at least the pre-stage of the logic calculation function block.

When an input signal indicating some kind of danger is obtained through such input system function block and/or invalidating function block, such input signal may not be immediately retrieved and provided to the necessary logic calculation (in particular, in a case of input signal from instantaneous operation/instantaneous recovery, contacting point) from reasons of safety regulation in that the state of the output signal cannot be recovered simultaneously with the recovery from the state indicating danger to the state indicating safety. Thus, a set/reset function block having a set function of holding the danger state of the input signal, a reset function of releasing the holding of the danger state, and a function of defining the reset condition sometimes may need to be arranged in at least the pre-stage of the logic calculation function block.

In view of the possibility of failure in the output equipment itself, it is not necessarily appropriate to transmit the output signal of a logic calculation output condition function block to the output equipment unconditionally. Thus, an external output equipment monitoring function block (e.g., EDM/function block) incorporating an appropriate failure diagnosis function etc. needs to be arranged in at least a post-stage of the output condition function block for every output equipment.

In view of the unique operation delay time of each output equipment, it is not necessarily appropriate to transmit the output signal from each of a plurality of output terminals at the same timing. Thus, a terminal mode function block having a function of delaying the ON timing and/or the OFF timing of the output signal may need to be arranged in at least the post-stage of the output condition function block.

Therefore, in programming of the safety controller interposing the logic circuit diagram, the user is requested to perform a task of appropriately arranging the necessary function block at a necessary position on a signal path from the input terminal to the output terminal. This task is suitably performed after sufficiently considering situations specific to the above described safety controller, and thus it is not easy for beginners who are not familiar with the programming of the safety controller, and necessary function blocks may be missing, and programming mistakes such as the necessary function block being present but arranged at the wrong position may arise.

In the first and second related arts, no strict correlation exists between the position at where each function block is to be arranged on the programming field and the type of function block to be arranged at the relevant position, and thus even if one of the plurality of function blocks to be originally arranged is missing by mistake or is arranged at the wrong position, it is difficult to immediately recognize such drawbacks from the layout of each function block.

Thus, in the related arts, in order to find the programming mistake, it needs a secure verification task of tracing the signal path from the input terminal to the output terminal in order while considering a specific control situation, and such complicatedness of the verification task is one cause that inhibits the widespread use of this type of safety controller.

The type of function block used in the programming of the safety controller is assumed to increase more and more with the widespread use of the safety controller, and thus there is desired a program development support apparatus of the safety controller that is less likely to cause programming mistake, and capable of easily finding the programming mistake if it occurs even under a future situation where numerous types of function blocks are assumed to exist.

In addition, since the setting of a unique parameter for defining the connecting relationship between the function blocks is designed to be performed through the drawing operation of the signal line connecting the relevant function blocks in the first and second related arts described above, a complicated operation of checking the wiring on the completed logic circuit diagram and the input/output relationship on the safety input/output equipment correspondence table (see FIG. 39) becomes necessary when attempting to verify the setting parameter of the output condition function block in the completed program relying on the logic circuit diagram, and thus verification becomes troublesome.

In view of the above problems, it is an object of the present invention to provide a program development support apparatus of a safety controller in which programming mistake such as the function block being arranged at the wrong position or being arranged in the wrong order is less likely to occur, and even if such programming mistake occurs, the programming mistake can be easily found, and in which the parameter verification of the output condition function block in the completed program is facilitated.

The above technical problems can be solved by a program development support apparatus of a safety controller having the following configuration.

The program development support apparatus of the safety controller has a basic configuration including a processing unit operated so that a control program for the safety controller is automatically generated through a series of user operations for completing a logic circuit diagram corresponding to the desired control specification by sequentially arranging one type of function block selected from a plurality of types of function blocks prepared in advance in a programming field on a screen of an image display and setting a necessary unique parameter for every function block.

In addition to such basic configuration, the program development support apparatus includes a guide display means, displayed on the programming field, for enabling the arrangement of the function block on the programming field according to a guide by a function block arrangement template defined with a block arrangeable position so as to correspond to each intersecting position of rows and columns, and having one end side in the row direction defined as the input terminal side and the other end side defined as the output terminal end side.

The function block arrangement template is separated into an input side template positioned on the input side and including a series of plural rows respectively accepting the arrangement of a predetermined type of function block related to an input signal, and an output side template positioned on the output side and including a series of plural columns respectively accepting the arrangement of a predetermined type of function block related to an output signal.

According to the configuration including the guide display means operating as above, the arrangement of the function block to the programming field is guided to the block arrangeable position displayed on the programming field and defined so as to correspond to each intersection position of rows and columns, and thus each function block is arranged while being automatically aligned vertically and horizontally, whereby the user does not need to be concerned with the layout of the function block.

Since the same types are lined in the column direction for each function block on the completed logic circuit, whether or not the same type of function blocks are lined may be checked in units of columns for verification of the completed logic circuit, or if the function block is missing in one of the rows, a mechanical check task of checking whether or not the arrangement of the relevant function block is forgotten may be checked, and thus verification of the completed logic circuit is facilitated.

Since the function block arrangement template is separated into the input side template positioned on the input side and including a series of plural rows respectively accepting the arrangement of a predetermined type of function block related to the input signal, and the output side template positioned on the output side and including a series of plural columns respectively accepting the arrangement a predetermined type of function block related to the output signal, the series of function blocks arranged in each row of the input side template handle one common input signal, and a series of function blocks arranged in each row of the output side template also handles one common output signal, whereby the correspondence relationship between each input/output signal system in the created logic circuit and each row of each template is clarified, and therefore a programming mistake of arranging the function block of one input (or output) signal system in a different input (or output) signal system less likely to occur.

If the input side template and the output side template are alternatively displayed on the programming field in the guide display means, the dedication can be made to one of the input side logic circuit or the output side logic circuit so that the arrangement of the function blocks of the relevant side is given exclusive attention, and the programming mistake further becomes less likely to occur.

In addition, if the input side template is first displayed and the output side template is subsequently displayed on the programming field in the guide display means, the user proceeds to the programming related to the output side logic circuit after completing the programming related to the input side logic circuit, where the programming result of the input side logic circuit is necessary in the programming of the output side logic circuit, and thus the programming mistake is less likely to occur.

In the program development support apparatus of the preferred embodiment of the present invention, the guide display means may include a leading means for leading each function block to an arrangement column defined in advance according to an arrangement procedure defined in advance so that the function block selected by a user is arranged on the block arrangeable position of the corresponding column on each template according to the arrangement column and the arrangement procedure defined in advance for every type.

According to such configuration, since the guide display means includes the “leading means for leading” described above, the function block selected by the user is not only arranged in the arrangement column defined in advance for every type, but also arranged at the block arrangeable position of the relevant column of each template according to the arrangement procedure (temporal arrangement order) defined in advance, and thus occurrence of programming mistake due to a failure of arranging another function block necessary in time of arrangement can be suppressed by defining the arrangement procedure such that arrangement of another function block that needs to be referenced in time of arrangement of each function block is completed beforehand.

In this case, the leading means for leading each function block to the scheduled arrangement column according to the scheduled arrangement order may be a guide display encouraging the necessary operations to the user.

According to such configuration, each function block can be led to the scheduled arrangement column according to the scheduled arrangement procedure through the operation of the user by acting on the mentality of the user through the guide display.

The leading means for leading each function block to the scheduled arrangement column according to the scheduled arrangement procedure may detect the operation in which the function block selected by the user is arranged on each template according to the arrangement column other than the arrangement column defined in advance for every type or arrangement procedure other than the arrangement procedure defined in advance for every type and prohibit the same, or detect the relevant operation and issue a warning.

According to such configuration, a mistaken function block arrangement operation can be eliminated by the prohibiting measure or the warning, so that each function block can be led to the scheduled arrangement column according to the scheduled arrangement procedure through the intended operation of the user or forcibly.

The leading means for leading each function block to the scheduled arrangement column according to the scheduled arrangement procedure forcibly rejects the arrangement of the function block other than the function block scheduled to be arranged in the corresponding column.

According to such forcible rejection method, each function block can be reliably arranged on the corresponding column on the signal path in the row direction from the input end to the output end irrespective of the will of the user by acting a physical force.

The leading means for leading the arrangement of each function block to the corresponding column may use the guide display method together with the forcible rejection method.

According to such configuration, each function block can be more reliably arranged at the corresponding column on the signal path in the row direction from the input end to the output end by acting on the mentality of the user through vision and acting physical force.

Various modes may be adopted for the guide display to encourage the user to arrange each function block at the corresponding column.

A first aspect includes arranging an index displaying the name of the function block to be arranged at the relevant column or the type name to which the function block belongs at the position corresponding to each column on the template.

A second aspect includes providing the same or common visual feature (e.g., same color, same or common ground pattern, same or common mark etc.) to each column on the template and the function block to be arranged at the relevant column.

A third aspect includes having the same outline shape for the arrangement scheduled region of each column on the template and for the function block to be arranged at the relevant column.

According to the above described guide display method, each signal path extending from the input end side to the output end side along the row direction traverses a series of columns, and thus forgetting of arrangement or arrangement mistake of the function block can be reduced by sequentially searching the column display that intersects each signal path along the same in a manner of a check list. Even after the arrangement of the function blocks is completed, the column display that intersects each signal path along the same can be similarly sequentially searched in a manner of a check list to easily verify forgetting of arrangement or arrangement mistake of the function block.

Various modes can be adopted for the forcible rejecting function for forcibly rejecting the function block other than the function block scheduled to be arranged from being arranged at the relevant column.

The first aspect includes presenting only the function block of the type arrangeable at the relevant column to the user as a menu (small window, pull-down menu etc.) for each column, and allowing the arrangement of the function block to the relevant column only when the selecting operation is made by the user on the menu.

The second aspect includes arranging a group of selectable function blocks in a specific region on a screen, where the function blocks can be moved to the programming field by the drag operation of the mouse but the function block cannot be position fixed even if drop operation is made at the column other than at the column in which the relevant function block can be arranged.

The third aspect includes arranging a group of selectable function blocks in a specific region on a screen, where the display of the function blocks is operated in conjunction with the specification of each column, and only the function blocks arrangeable in the relevant column are activated, and moved to the programming field through a drag-and-drop operation only in the active state and fixed at the relevant column.

In this case, when the template is the input side template the arrangement procedure defined in advance may be the arrangement procedure to arrange each function block in order from the column close to the input terminal side.

Such configuration is effective in suppressing programming mistake when arranging a plurality of function blocks in line in each column of the input side template so as to be processed in order from the function blocks close to the input terminal side to facilitate the understanding of the circuit operation.

When the template is the output side template, the arrangement procedure defined in advance may be the arrangement procedure to arrange each function block in order from the column close to the output terminal side.

Such configuration is effective in suppressing programming mistake when arranging a plurality of function blocks in line in each column of the output side template so as to be processed in order from the function blocks close to the output terminal side to facilitate the understanding of the circuit operation.

In addition, a setting on a correspondence relationship between at least an input terminal and an input equipment input to the input terminal is required for every function block when arranging each function block on the input side template, the set correspondence relationship being recorded in a storage medium of the apparatus as an input equipment table when the setting is completed on the input side template; a setting of an input signal is required at least as a unique parameter at an output condition function block, which is one of the function blocks, when arranging each function block on the output side template; and an input signal setting means for enabling an operation of selecting a desired input signal from a menu displayed input signal list by referencing the input equipment table when setting the input signal is further arranged, and thus anyone can easily perform verification after the completion of the program by checking the safety input/output equipment correspondence table normally created prior to this type of programming and the menu displayed input signal list, as opposed to the related art example where the wiring on the logic circuit diagram needs to be tracked back, and the task of separately registering the input signal data becomes unnecessary for menu display.

The selecting operation of the input signal, as well as, the verification task after the completion of the program are further facilitated by performing the menu display of the input signal list by arraying the input signal names to be set within the menu window opened on the screen of the image display.

It should be noted that various other modes can be adopted for the mode of menu display of the input signal list. For instance, if the number of input terminals increases such as sixteen points, thirty-two points, and sixty-four points, the number of input signals to be selected increases in correspondence to the increased number of input terminals, in which case, the input signals are menu displayed over a number of times by dividing the input signals into few groups.

If the range of input signal associated with the target output condition function block can be logically estimated to a certain extent when the number of input points is in great numbers, AI function can be provided such that menu display is carried out by preferentially narrowing the input signals belonging to a group of high possibility or narrowing down to the input signals belonging to the relevant group, whereby the selecting operation can be efficiently performed.

Regarding the input signal display in the menu displayed input signal list, the name, symbol, and the like of the target input terminal can be used in addition to the name, the symbol, and the like representing the input signal, and under the condition that there is an extra space in the display screen, if a general form of the safety input/output equipment correspondence table to be compared is known, the safety input/output equipment correspondence table can be displayed in a graphical form by executing an inverse assembly process based on the set input signal data for each output condition function block and the safety output equipment data assigned to each output terminal to further facilitate the check.

According to the present invention, there is provided a program development support apparatus of a safety controller in which the programming mistake such as arranging the function block at the wrong position or in the wrong order is less likely to occur, and even if such programming mistake occurs, such mistake can be easily found, and parameter verification of the output condition function block in the completed program is facilitated.

### BRIEF DESCRIPTION OF THE DRAWINGS

FIGS. 1A and 1B show conceptual views of a safety control system including a safety controller;

FIG. 2 shows a block diagram conceptually showing functions of a program development support apparatus;

FIG. 3 shows a schematic block diagram of an electrical hardware configuration of the program development support apparatus;

FIG. 4 shows a schematic block diagram of an electrical hardware configuration of the safety controller;

FIG. 5 shows a flowchart (No. 1) of a software configuration of the program development support apparatus (first embodiment);

FIG. 6 shows a flowchart (No. 2) of a software configuration of the program development support apparatus (first embodiment);

FIG. 7 shows a flowchart (No. 3) of a software configuration of the program development support apparatus (first embodiment);

FIG. 8 shows a detailed flowchart (process corresponding to invalidating function block) of the input side circuit diagram data generating process;

FIG. 9 shows a detailed flowchart (process corresponding to set/reset function block) of the input side circuit diagram data generating process;

FIG. 10 shows a detailed flowchart (process corresponding to terminal mode function block) of an output side circuit diagram data generating process;

FIG. 11 shows a detailed flowchart (process corresponding to EDM function block) of the output side circuit diagram data generating process;

FIG. 12 shows a detailed flowchart (process corresponding to output condition function block) of the output side circuit diagram data generating process;

FIG. 13 shows a flowchart (No. 1) of a software configuration of the program development support apparatus (second embodiment);

FIG. 14 shows a flowchart (No. 2) of a software configuration of the program development support apparatus (second embodiment);

FIG. 15 shows a flowchart (No. 1) of a software configuration of the program development support apparatus (third embodiment);

FIG. 16 shows a flowchart (No. 2) of a software configuration of the program development support apparatus (third embodiment);

FIG. 17 shows a detailed flowchart of a safety output condition setting process;

FIG. 18 shows an explanatory view of one example of safety program template data (input side);

FIG. 19 shows an explanatory view of one example of safety program template data (output side);

FIG. 20 shows an explanatory view of one example of a logic circuit data (10b) created by a user;

FIG. 21 shows an explanatory view of an input equipment table;

FIG. 22 shows an explanatory view of an output condition setting table;

FIG. 23 shows an explanatory view of one example of setting parameter data (control program) downloaded to the safety controller;

FIG. 24 shows a screen explanatory view at the initial stage of start of a FB arrangement on an input side template;

FIGS. 25A and 25B show explanatory views of an FB selection menu window;

FIGS. 26A and 26B show explanatory views of an input invalidating condition setting menu window;

FIGS. 27A and 27B show explanatory views of a reset condition setting menu window;

FIG. 28 shows a screen explanatory view of the input side template arranged with an input FB, an invalidating condition FB, and a reset FB;

FIG. 29 shows a screen explanatory view at the initial stage of start of a FB arrangement setting on an output side template;

FIGS. 30A and 30B show screen explanatory views of various menu windows related to a welding check;

FIGS. 31A and 31B show explanatory views of a terminal mode setting menu window;

FIG. 32 shows an explanatory view of an output condition setting window;

FIG. 33 shows a check screen explanatory view at completion of FB arrangement on the input side template;

FIG. 34 shows a check screen explanatory view at completion of FB arrangement on the output side template;

FIG. 35 shows a screen explanatory view of a warning window displayed when the arrangement procedure of the FB is mistake;

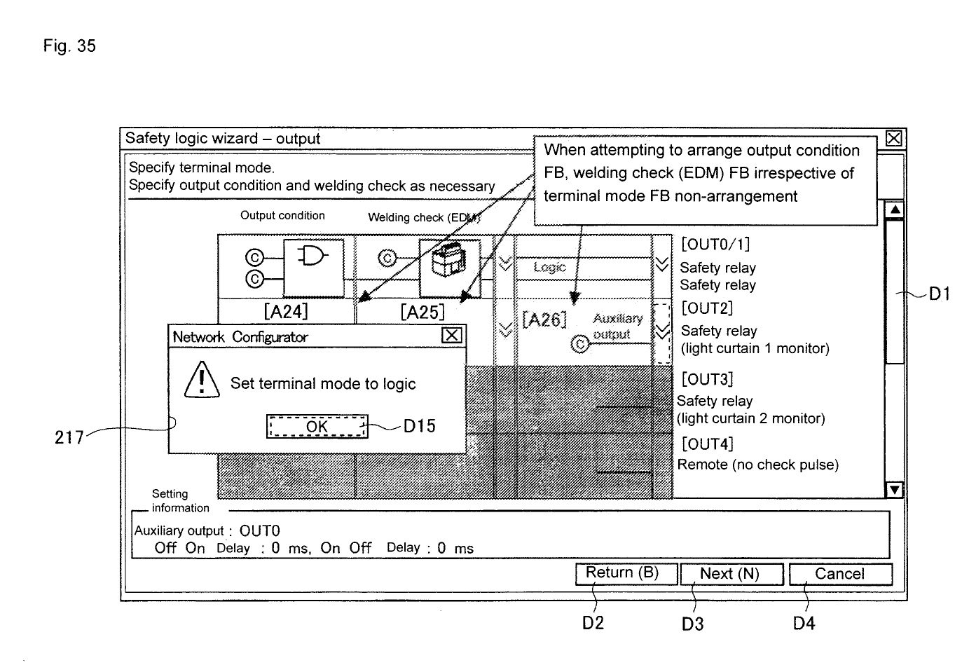

FIG. 36 shows an explanatory view of preferred arrangement example and arrangement procedure of each FB;

FIG. 37 shows a logic circuit diagram display example according to a program development support apparatus (first related art);

FIG. 38 shows a logic circuit diagram display example according to a program development support apparatus (second related art); and

FIG. 39 shows an explanatory view of a safety input/output equipment correspondence table.

### DETAILED DESCRIPTION OF THE PREFERRED EMBODIMENTS

Suitable embodiments of the program development support apparatus of a safety controller according to the present invention will be described in detail with reference to the accompanying drawings.

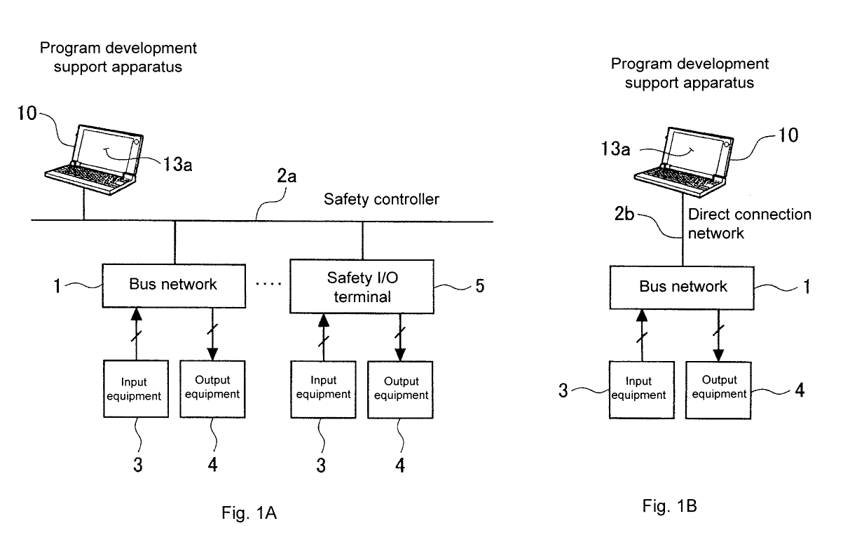

FIG. 1 shows a conceptual diagram showing a safety control system including the safety controller serving as a target of the program development support apparatus according to the present invention. The safety control system shown in FIG. 1A is configured by connecting one safety controller 1 and two or more safety I/O terminals 5 through a bus network 2a. In the safety control system shown in FIG. 1A, the safety controller 1 serves as a master, and the safety I/O terminal 5 serves as a slave.

An input equipment 3, and an output equipment 4 are respectively connected to the safety controller 1 and the safety I/O terminal 5. The input equipment 3 may be a safety emergency stop switch, a safety light curtain, a safety limit switch, a safety door switch, and the like. The output equipment 4 may be a safety relay, a safety contact, and the like.

When applied to a master-slave safety control system shown in FIG. 1A, the program development support apparatus 10 of the present invention can be connected to the bus network 2a connecting the safety controller 1 and each safety I/O terminal 5. When applied to an independent control system shown in FIG. 1B, on the other hand, the program development support apparatus 10 of the present invention is directly connected by way of a predetermined cable 2b. The control program related to safety generated in the program development support apparatus 10 is then converted to a format executable by each safety controller 1, and then sent to the safety controller 1.

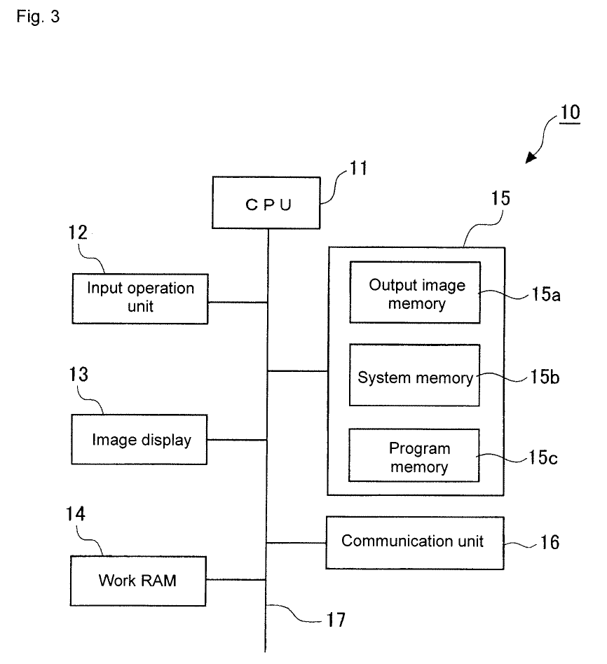

FIG. 3 shows a schematic block diagram showing an electrical hardware configuration of the program development support apparatus according to the present invention. As apparent with reference to FIGS. 1 and 3, the program development support apparatus 10 is configured with a laptop as a main body in the illustrated example.

The hardware configuration of the laptop is configured by connecting a CPU 11, an input operation unit 12, an image display 13, a work RAM 14, a storage device 15, and a communication unit 16 by a system bus 17, as well known by persons skilled in the art.

The CPU 11 is configured with a microprocessor as a main body, and overall controls the entire laptop. The input operation unit 12 is configured with mouse, keyboard, and the like as a main body, and serves as a human machine interface for giving the laptop various instructions.

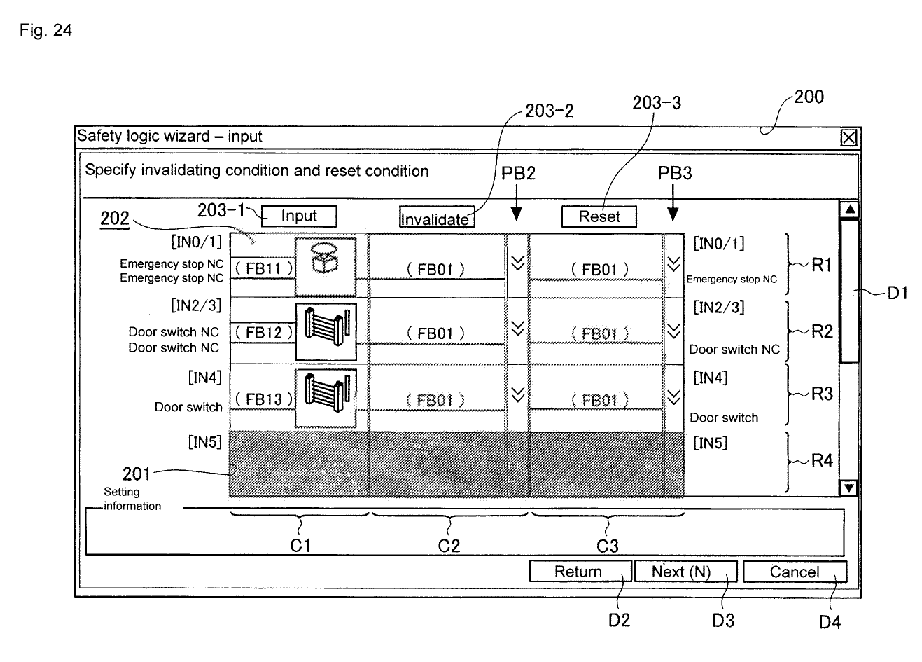

The image display 13 is configured by a liquid crystal display etc., where a programming field 201 according to the present invention is displayed on a screen 13a of the image display 13 as hereinafter described in detail with reference to FIG. 24 and the like. The work RAM 14 is used as a work area when the CPU 11 executes system program, application program, and the like to be hereinafter described.

The storage device 15 is configured by a hard disc, and the like, and includes therein an output image memory 15a, a system memory 15b, and a program memory 15c. In relation to the present invention, the output image memory 15a is used to store various image data when displaying various images on the screen 13a of the image display 13, and the system memory 15b is used to store firmware (include operating system) for configuring the basic functions of the laptop. The program memory 15c is used to store various application programs to be executed in the laptop.

As described above, it is well known that various programs and data stored in the output image memory 15a, the system memory 15b, and the program memory 15c are developed and executed on the work area of the work RAM 14 when they are executed by the CPU 11.

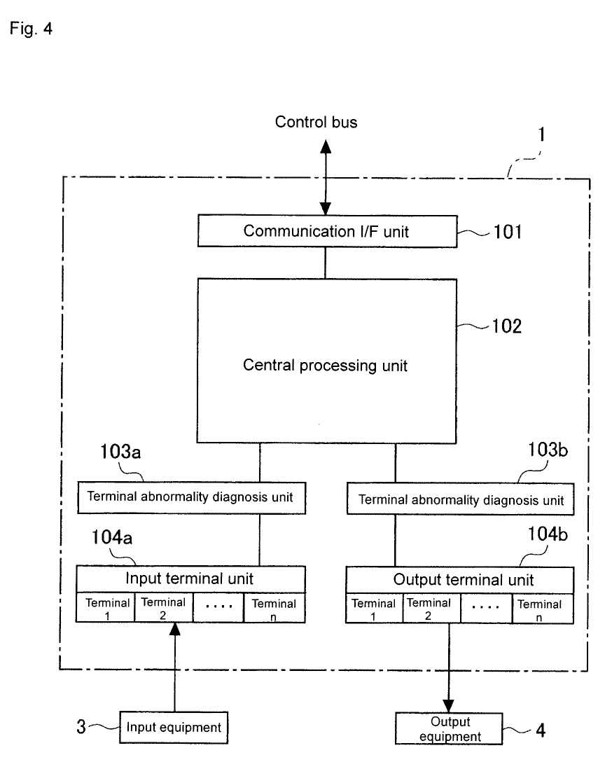

FIG. 4 shows a schematic block diagram showing an electrical hardware configuration of the safety controller 1. As shown in the figure, the safety controller 1 includes therein a communication I/F unit 101, a central processing unit 102, an input terminal unit 104a, and an output terminal unit 104b.

The communication I/F unit 101 is provided to realize an interface function when carrying out communication between the safety controller 1 and the network 2a, 2b. The central processing unit 102 overall controls the entire safety controller 1, and is configured with the microprocessor, the ROM, the RAM, and the like as main bodies.

The input terminal unit 104a includes a plurality of input terminals (terminal 1, terminal 2, . . . , terminal n) for receiving signals from the input equipment 3. The output terminal unit 104b includes a plurality of output terminals (terminal 1, terminal 2, . . . , terminal n) for transmitting output signals to the output equipment 4.

A terminal abnormality diagnosis unit 103a on the input side includes individual diagnosis units respectively corresponding to each input terminal of the input terminal unit 104a. Each individual diagnosis unit is configured as a general purpose diagnosis unit corresponding to a plurality of input equipment types, where the diagnosis unit is set with a parameter corresponding to each input equipment type so that the diagnosis unit is structured in a form specialized for the relevant equipment type. In the programming task described later, it is the parameter for specializing the terminal abnormality diagnosis unit 103a to each input equipment type that appears as the parameter of the input system function block.

A terminal abnormality diagnosis unit 103b on the outside similarly includes individual diagnosis units respectively corresponding to each output terminal of the output terminal unit 104b. Each individual diagnosis unit is configured as a general purpose diagnosis unit corresponding to a plurality of output equipment types, where the diagnosis unit is set with a parameter corresponding to each output equipment type so as to be specialized as a diagnosis unit corresponding to the relevant output equipment type.

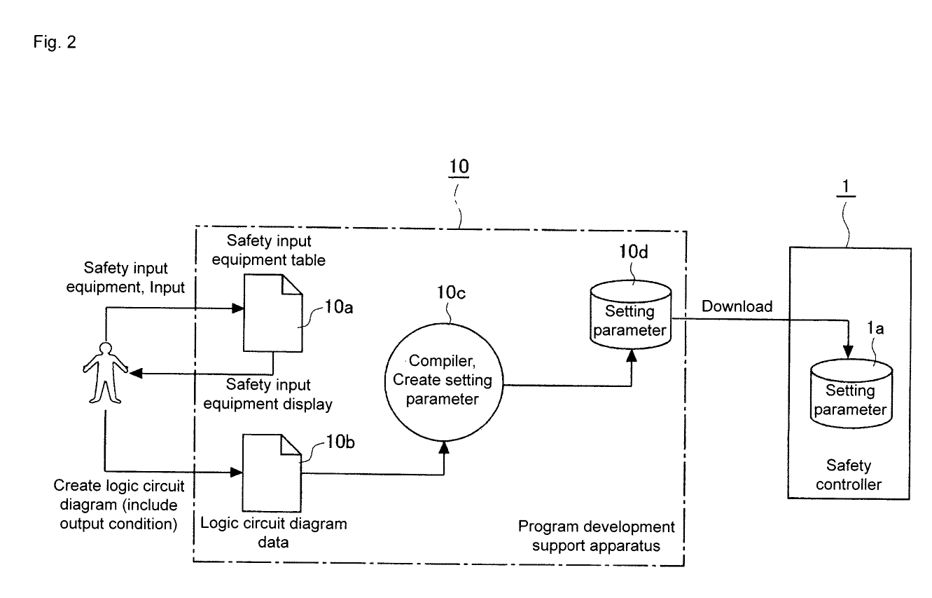

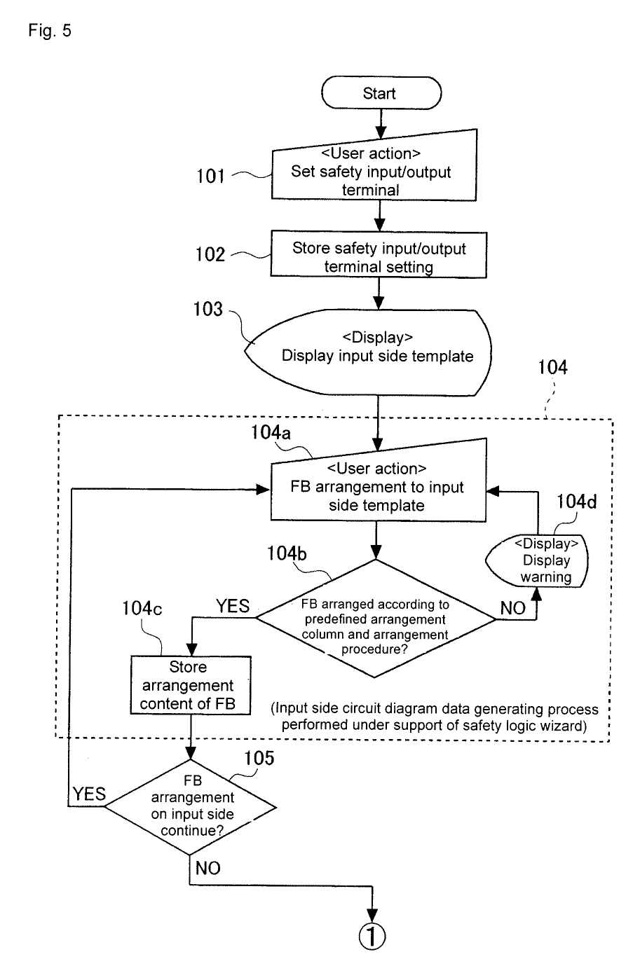

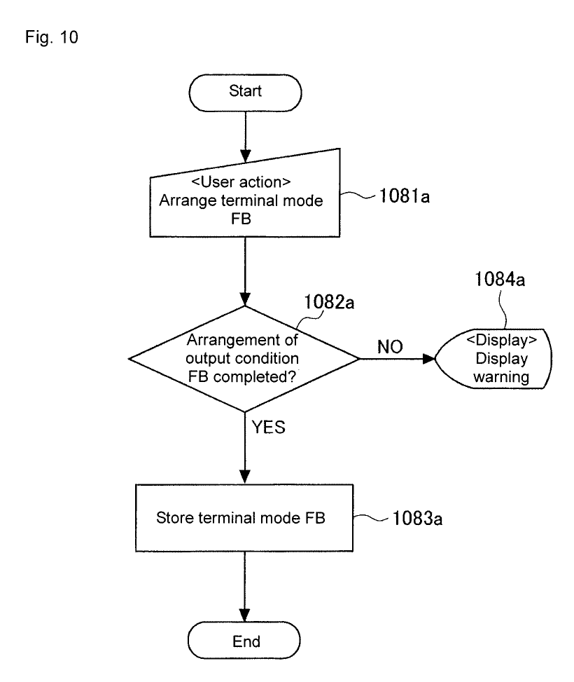

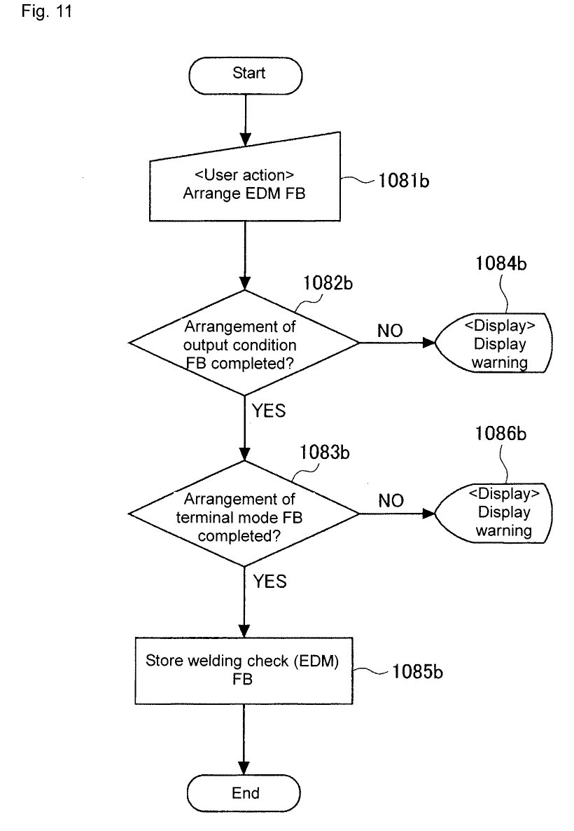

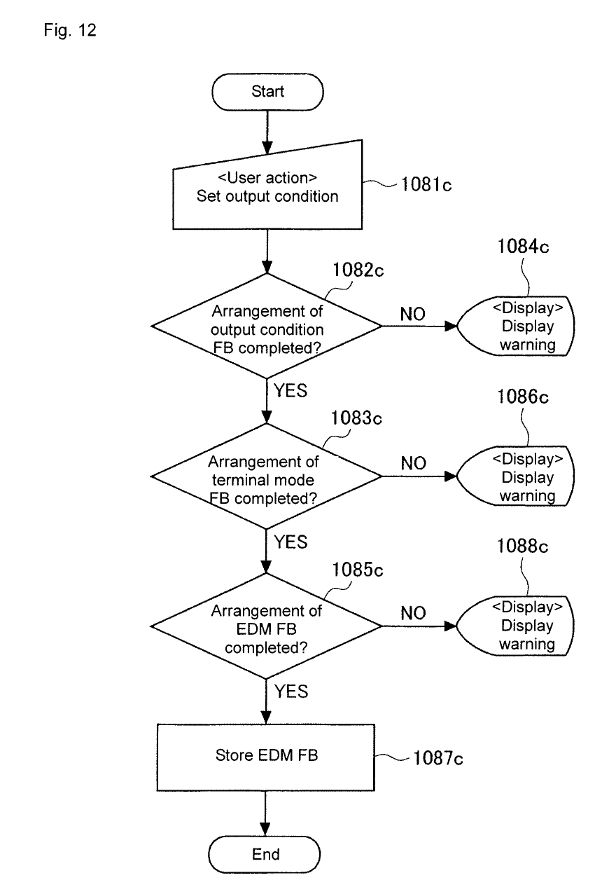

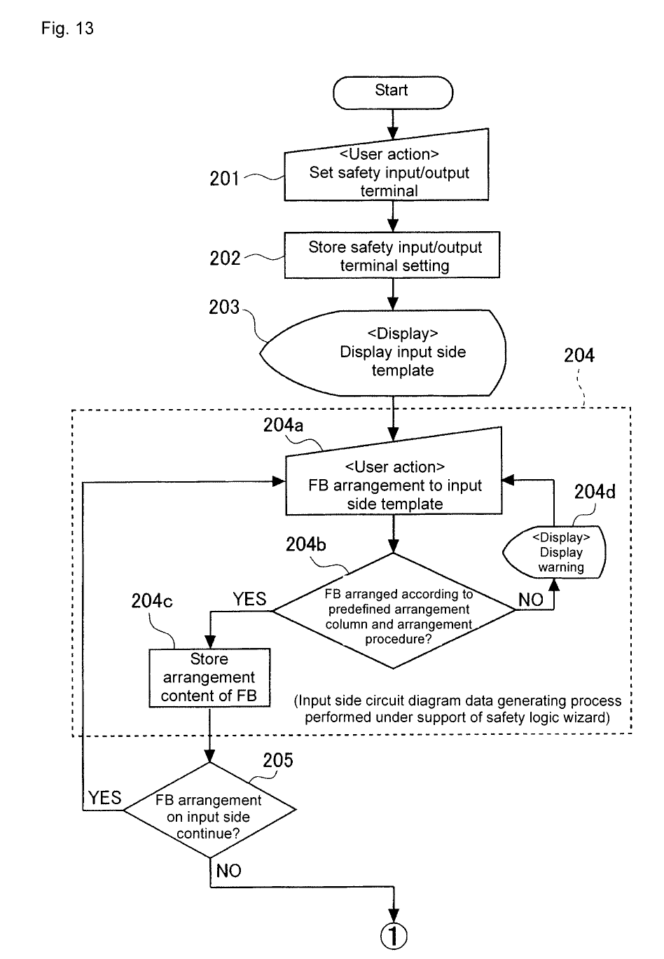

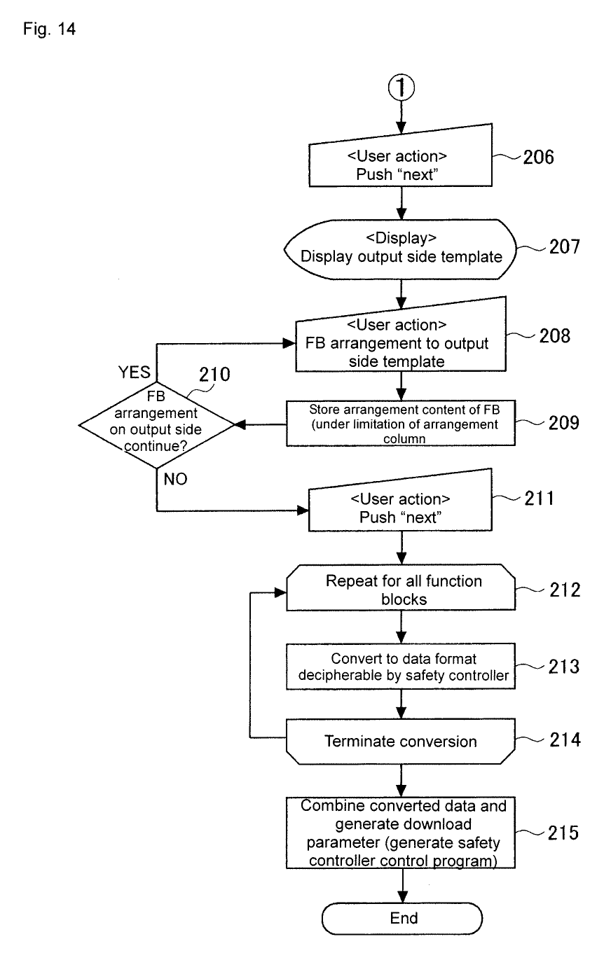

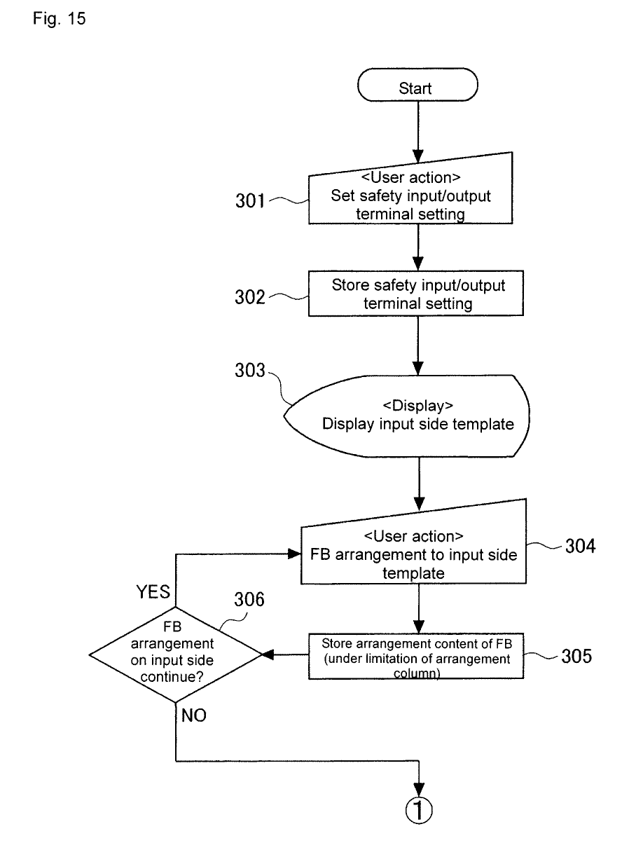

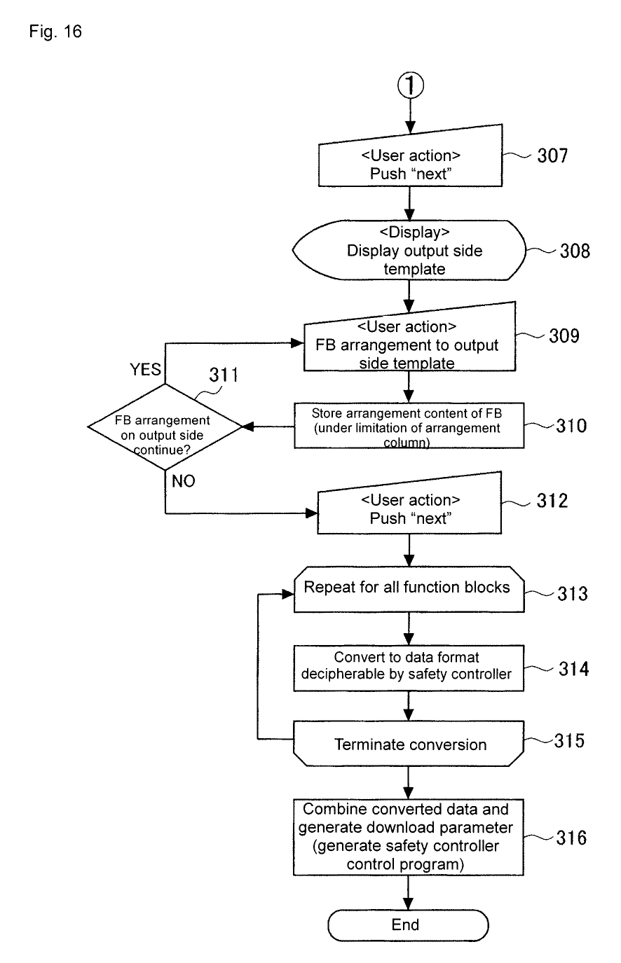

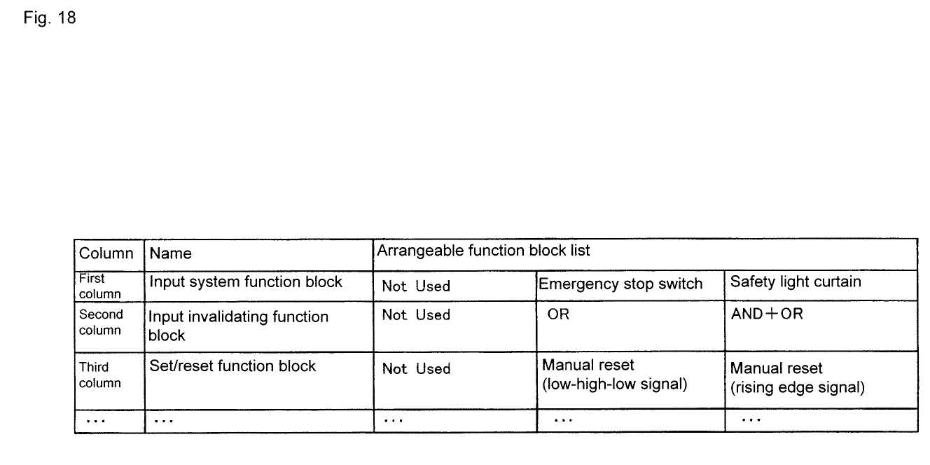

FIG. 2 shows a block diagram conceptually showing the function of the program development support apparatus 10. As shown in the figure, when focusing on the configuration for realizing the present invention, the functional components necessary for the program development support apparatus 10 includes a safety input equipment table 10a, a logic circuit diagram data 10b, a compiler 10c for creating a setting parameter, and a setting parameter 10d converted from the logic circuit diagram data 10b through the compiler 10c. The functional components will be described in detail with reference to the diagrams shown in FIGS. 18 to 23, as well as the flowcharts shown in FIGS. 5 to 17 in describing the operation of the program development support apparatus according to the present invention.

The operation of the program development support apparatus according to the present invention will be described with reference to FIGS. 5 to 17. The application program shown in the respective flowcharts is stored in the program memory 15c described with reference to FIG. 3 above. The operation shown in the flowcharts is execution processed under the control of the CPU 11 corresponding to the processing unit.

FIGS. 5 to 17 show a flowchart showing software configuration of the program development support apparatus.

In FIG. 5, when the process is started, a process of accepting user action for setting of a safety input/output terminal is executed (step 101). The user action includes a predetermined key input operation, mouse operation, and the like in the laptop configuring the program development support apparatus 10. Various data related to the safety input/output terminal are set by such user action. The various data related to the safety input/output terminal obtained in this manner are stored in the work RAM 14 (step 102).

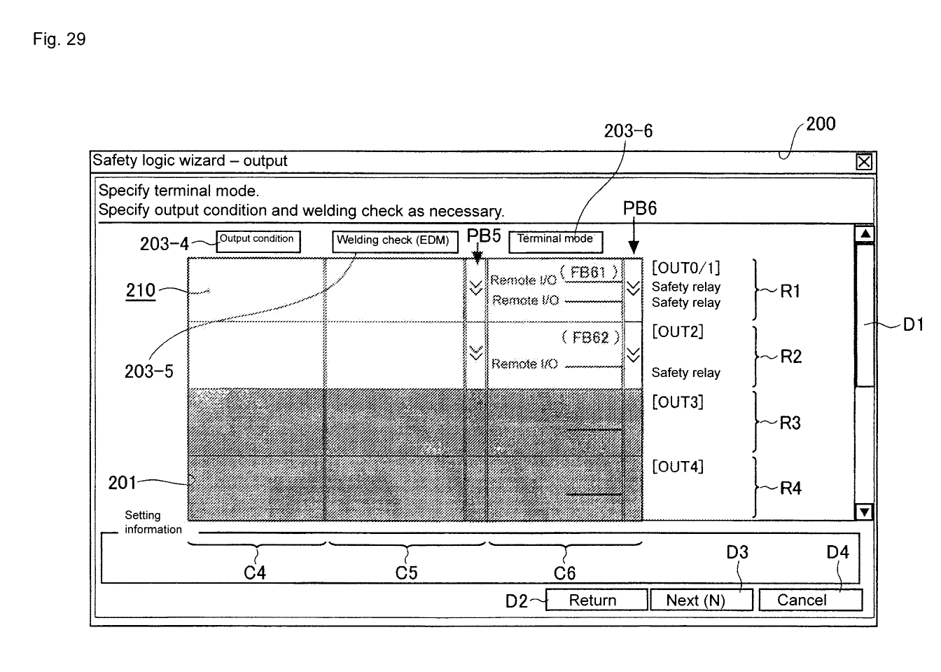

FIG. 24 shows a screen explanatory view at the initial stage of start of a function block (hereinafter also referred to as “FB”) arrangement on the input side template, and FIG. 29 shows a screen explanatory view at the initial stage of start of a FB arrangement setting on the output side template.

As shown in FIG. 24, a window 200 for input safety logic wizard is opened on the screen 13a of the image display 13 of the laptop configuring the program development support apparatus 10. Here, “safety logic wizard” is a collective term for various user support functions for creating the logic circuit diagram corresponding to the control program for the safety controller.

The programming field 201 having a horizontally long rectangular shape is defined in the opened window 200, and the input template 202 of the main part of the present invention is displayed in the programming field 201.

On the input side template 202, a plurality of block arrangeable positions is provided so as to correspond to each intersecting point of rows (R1, R2, R3, . . . ) extending in the horizontal direction of the screen and columns (C1, C2, C3) extending in the vertical direction of the screen. Information related to the input terminal of the relevant row is displayed in correspondence to each row (R1, R2, R3, R4, . . . ) at the left side edge of the input side template 202.

In this example, the first row (R1) is assigned to two input terminals [IN0/1], and such input terminals are set to receive a pair of NC (Normal Close) signals from the safety emergency stop switch of duplication specification. The second row (R2) is assigned to two input terminals [IN2/3], and such input terminals are set to receive a pair of NC signals from the safety door switch of duplication specification. The third row (R3) is assigned to one input terminal [IN4], and such input terminal is set to receive a signal from the door switch of non-duplication specification.

In correspondence to the setting of such input terminals, the function blocks for realizing the self-diagnosis function related to the respective terminals are arranged so as to correspond to the terminal setting of each row (R1, R2, R3) in the first column (C1) of the input side template 202.

In other words, a safety emergency stop switch function block (FB11) is arranged in a block arrangeable position (small region of horizontally long rectangular shape) corresponding to the first row (R1) of the first column (C1), a safety light curtain function block (FB12) of duplication specification is arranged in the function block arrangeable position corresponding to the second row, and a safety light curtain function block (FB13) of non-duplication specification is arranged in the function block arrangeable position corresponding to the third row (R3), respectively.

Returning back to the flowchart of FIG. 5, after the processes of steps 101, 102 are executed, the setting of the input terminal described above and the arrangement of the function blocks are executed.

The input invalidating function block or the input/output conduction function block (FB01) is designed to be arranged at the block arrangement position of each row of the second column (C2) on the input side template 202, and similarly, the set/reset function block or the input/output conduction function block (FB01) is designed to be arranged at the block arrangement position of each row of the third column (C3). Such design is realized by having the function block selectable for every column to be selectable only from the menu window.

Indices 203-1 to 203-3 indicating the content of the function block to be arranged at the relevant column are displayed at the upper edge of the input side template 202 in correspondence to each column (C1, C2, C3). The content of the index 203-1 corresponding to the first column (C1) is “input” indicating the input system function block, the content of the index 203-2 corresponding to the second column (C2) is “invalid” indicating the input invalidating function block, and the content of the index 203-3 corresponding to the third column (C3) is “reset” indicating the set/reset function block.

The input display information same as the input display information at the left side edge of the input side template 202 is displayed on the right side edge thereof for each row (R1, R2, R3, R4, . . . ). That is, each row is assigned to one input signal in row units on the input side template.

Thus, according to the input side template 202 having such structure, the function blocks related to the same input signal are arranged in the same row, and the function blocks of the same type are arranged in the same column, and thus programming mistake such as arranging the function block to be arranged on a certain input signal path at a different input signal path, or arranging a plurality of function blocks to be arrayed in a certain order in a different order is less likely to occur.

FIG. 29 shows the screen explanatory view at the initial stage of the start of the FB arrangement setting on the output side template. As shown in the figure, an output side template 210 is displayed in the programming field 201 in the window 200 opened on the screen in this example. On the output side template 210, the block arrangeable positions (small region of horizontally long rectangular shape) are defined in correspondence to each intersecting point of the rows (R1, R2, R3, R4, . . . ) and the columns (C4, C5, C6).

The terminal information related to the relevant row is displayed in correspondence to each row (R1, R2, R3, R4, . . . ) at the right side edge of the output side template 210. In the illustrated example, the first row (R1) is assigned to two output terminals [OUT0/1] having safety specification, and each of such output terminals are wire connected to two safety relays. The second row (R2) is assigned to one output terminal [OUT2], and such output terminal is wire connected to one safety relay. In this example, the third row (R3) and the fourth row (R4) are respectively assigned to one output terminal [OUT3] and [OUT4], but the wire connecting destinations of such output terminals are not determined.

The fourth column (C4) positioned at the first stage of the output side template 210 is assigned to an output condition function block, the fifth column (C5) or the next column is assigned to a welding check (EDM) function block, and the sixth column (C6) or the following column is assigned to a terminal mode function block.

To clarify the above, indices 203-4 to 203-6 indicating the function block to be arranged in the relevant column are displayed at the upper edge of the output side template 210 in correspondence to each column (C4, C5, C6).

Specifically, the content of the index 203-4 is “output condition” indicating the output condition function block of determining at which logic values of the one, or two or more input signals the output is to be generate. The content of the index 203-5 is “welding check (EDM)” indicating the welding check (EDM) function block for performing the welding check of the safety relay connected to the output terminal. The content of the index 203-6 is “terminal mode” indicating the terminal mode function block for setting the terminal mode of on-delay, off-delay, and the like.

In this initial stage screen, the remote I/O function block (FB61) is arranged at the block arrangeable position of the first row (R1) of the sixth column (C6), and the remote I/O function block (FB62) is arranged at the block arrangeable position of the second row (R2).

It should be noted that the important point is that, similar to the case of the input side template described above, each column (C4, C5, C6) is respectively assigned to a specific type of function block, and in particular, the column (C4) positioned at the first stage is assigned to the output condition function block on the output side template, and thus the function blocks related to the output signal obtained with the output conditions met are arranged at the block arrangeable positions of the row in which the output condition function block is arranged in at least the column (C4).

According to such output side template, the function blocks performing the processes related to the same output signal may be arranged in the row same as the row in which the output condition function block for generating the relevant output signal is arranged, and the function blocks of the same type are respectively arranged in a specific column, and thus programming mistake such as arranging the function block to be arranged on a certain output signal path at a different output signal path, or arranging a plurality of function blocks to be arrayed in a certain order in a different order is less likely to occur, similar to the input side template.

According to the program development support apparatus of the present invention, the entire template is displayed separated into the input side template 202 and the output side template 210, as shown separated in FIGS. 24 and 29, and thus the programming mistake is less likely to occur compared to a case where the templates are integrally joined and displayed.

In addition, the arrangement error of the function block caused by mistaken recognition of the input signal path and the output signal path can be more reliably prevented by not only separating the template to the input side and the output side, but also by alternatively displaying the input side template 202 and the output side template 210 on separate screens.

In FIGS. 24 and 29 described above, D1 is scroll bar for scrolling the screen in the vertical direction, D2 is “return” button for forcibly returning to the previous screen, D3 is “next” button for forcibly moving on to the next screen, and D4 is cancel button for canceling various commands.

As apparent from the presence of the scroll bar D1, the input side template 202 and the output side template 210 can be extended in the vertical direction by an arbitrary length as the required input terminals increase to eight points, sixteen points, thirty-two points, sixty-four points, and so on, in which case, a specific row hidden from the screen can be brought into the programming field 200 by operating the scroll bar D1.

In the present invention, the safety logic wizard described above is adopted to prevent programming mistake caused by various reasons on the input side template 202 and the output side template 210 described above. The content of the safety logic wizard will be described in detail below with reference to the charts of FIGS. 18 to 23.

Returning back to FIG. 5, after the storing of the safety input/output terminal setting is completed (step 102), display of the input side template 202 applied with the safety logic wizard is performed (step 103) as shown in FIG. 24. Thereafter, an input side circuit diagram data generating process (step 104), which is the main part of the present invention, is executed. The input side circuit diagram data generating process is performed under the support of the safety logic wizard.

As shown in FIG. 5, the input side circuit diagram data generating process (step 104) determines whether or not the FB is arranged according to the predefined “arrangement column” and “arrangement procedure” (step 104b) every time the user action for FB arrangement to the input side template is carried out (step 104a), where if the FB is arranged according to the predefined “arrangement column” and “arrangement procedure” (YES in step 104b), the arrangement content of the relevant FB is stored (registered) (step 104c), the intention to continue FB arrangement on the user side is confirmed (step 105), and the next user action is waited (step 104a) to repeat the similar process. If determined that the FB is not arranged according to the predefined “arrangement column” and “arrangement procedure” (NO in step 104b), the arrangement content of such FB is not stored (registered), and the process of displaying a predetermined warning on the screen (step 104d) is repeated until the intention to continue FB arrangement on the input side of the user is confirmed (step 105).

The predefined “arrangement column” serving as a determination standard defines which column on the input side template 202 to arrange each function block, and is stored in the work RAM 14 etc. as safety program template data (input side), as shown in FIG. 18.

As shown in FIG. 18, the safety program template data (input side) is configured by storing, in form of a table, the “type name” (input system function block etc.) of the function block that is allowed to be stored in the relevant column and the list of the individual function block included in the relevant “type name” in association with each other for each column (first column, second column, third column, . . . ).

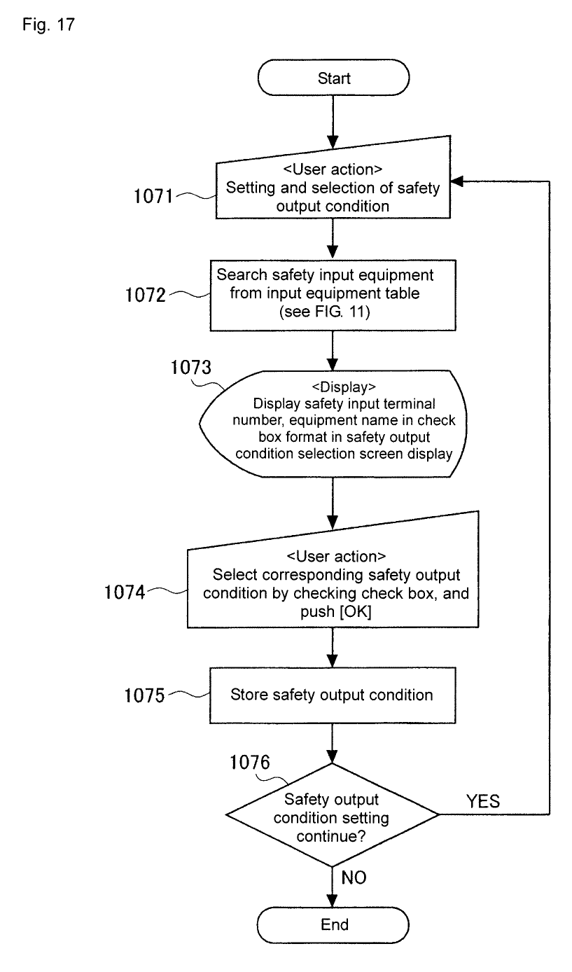

Returning back to FIG. 5, the combination of the “column” specified in the user action (104a) and the specific “function block name” is checked with the safety program template data (input side) shown in FIG. 17 to determine whether or not the FB is arranged according to the predefined “arrangement column” in the determination process of step 104b.

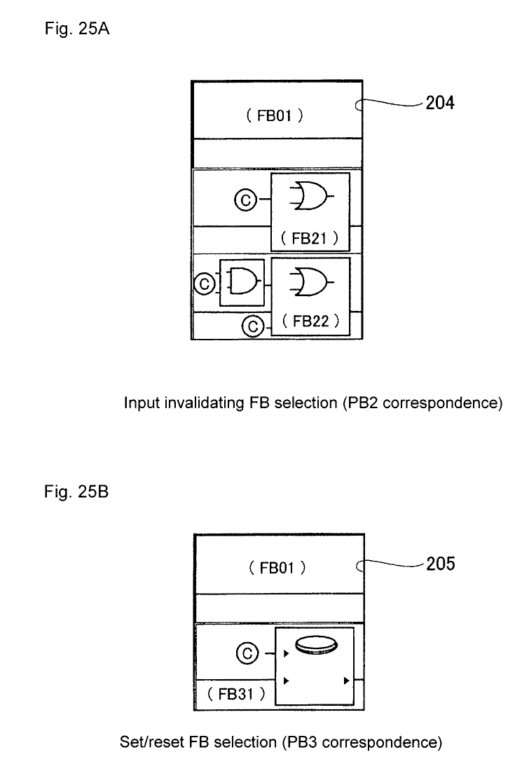

On the input side template 202 shown in FIG. 24, the pull-down button (PB2) of the first row (R1) is clicked with a mouse when desiring to arrange the logic operation OR function block (FB21) at the block arrangeable position of the second column (C2) of the first row (R1), for example. A menu window 204 is then opened so as to overlap the input side template 202, as shown in FIG. 25A.

Three function blocks are vertically displayed over three stages on the menu window 204. The three function blocks are the input/output conduction function block (FB01), the logic operation OR function block (FB21), and the logic operation AND and OR function block (FB22). In this state, if the logic operation OR function block (FB21) is selected through a predetermined operation of the mouse and the like, the selected function block (FB21) is arranged at the block arrangeable position specified by the first row (R1) and the second column (C2).

Similarly, a pull-down button PB3 of the third column is operated when desiring to arrange the set/reset function block (FB31) at the block arrangeable position positioned at the third column (C3) of the first row (R1). A menu window 205 is then opened as shown in FIG. 25B.

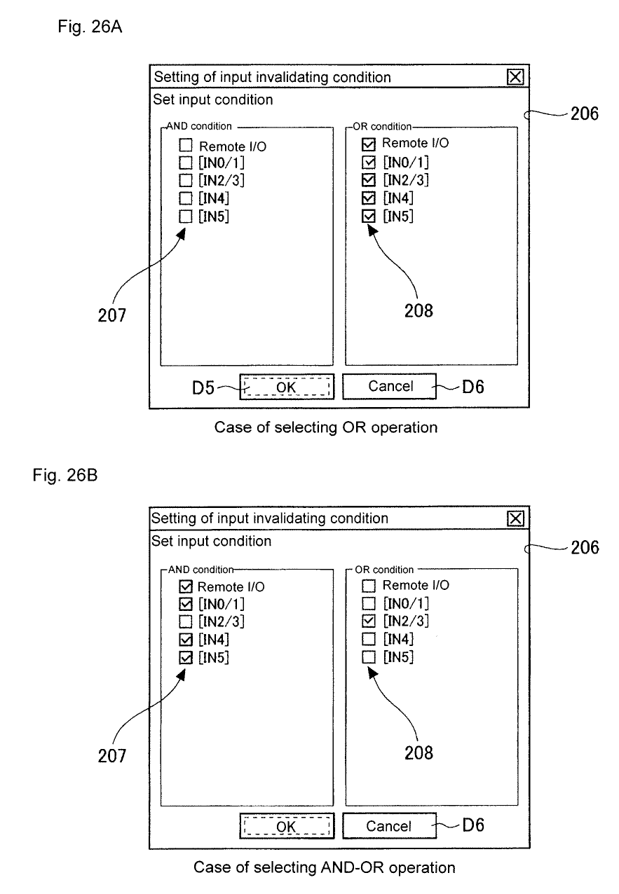

The selectable function blocks are vertically displayed over two stages in the menu window 205. The function blocks are the input/output conduction function block (FB01) and the set/reset function block (FB31). In this state, if the set/reset function block (FB31) is selected through a click operation of the mouse and the like, the selected function block (FB31) is arranged at the block arrangeable position positioned at the third column (C3) of the first row (R1). When setting the input invalidating condition from this state, a menu window 206 shown in FIG. 26 is further opened by a predetermined operation of the mouse.

As shown in the figure, a signal name column for AND condition setting and a signal name column for OR condition setting are displayed in the menu window 206, and check box columns 207, 208 are displayed at the head of the signal names configuring the respective signal name columns.

If the OR operation is selected in the menu window 204 shown in FIG. 25A, a check mark is made with the click operation etc. of the mouse within the OR condition setting area of the menu window 206, as shown in FIG. 26A. If the AND operation (not shown) is selected in the menu window 204 shown in FIG. 25A, a check mark is made with the mouse operation etc. with respect to the check box 207 of the corresponding input signal name within the AND condition setting area of the menu window 206, as shown in FIG. 26B. The selection of the input invalidating function block and the setting of the input invalidating condition can be easily carried out by anyone through such operation.

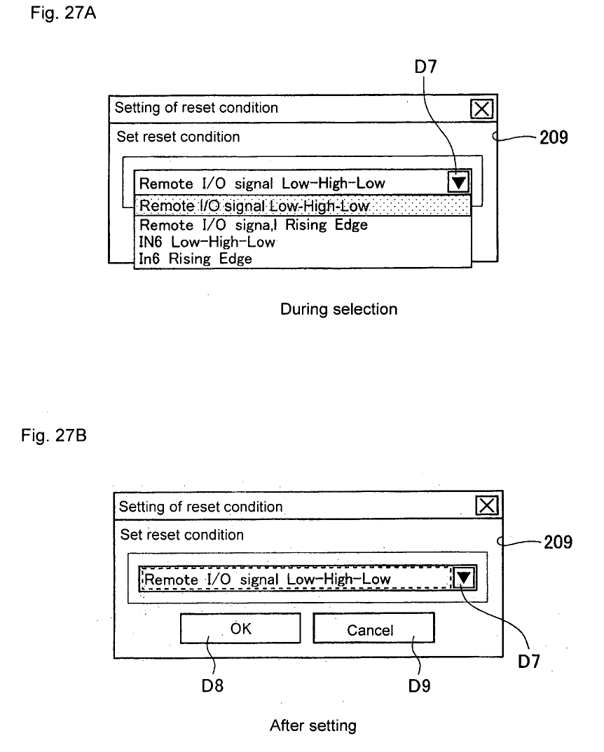

When setting the reset condition after selecting the set/reset function block, a menu window 209 is opened as shown in FIG. 27 to perform the setting of the corresponding reset condition. That is, as shown in FIG. 27A, a reset condition list is displayed when a pull-down menu button D7 is operated with a mouse in the menu window 209, an optimum reset condition is set therefrom, and thereafter, as shown in FIG. 27B, an OK button D8 is operated to easily set the desired reset condition. A cancel button D9 is operated when canceling to redo the reset condition.

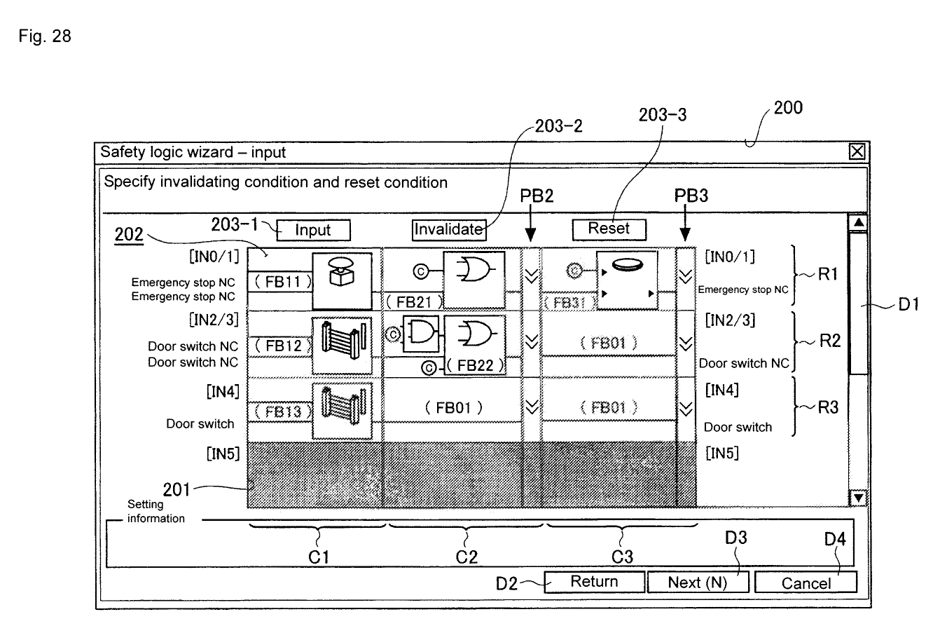

FIG. 28 shows an example of the input side template after the selection of the function block and the setting of each condition are performed. As shown in the figure, the input system function block, the invalidating condition function block, and the reset function block can be arranged in a desired manner by the selecting and specifying operation.

Returning back to FIG. 5, determination on whether or not the FB is arranged according to the predefined “arrangement procedure” is also made in the input side circuit diagram data generating process 104 performed under the support of the safety logic wizard. Here, predefined “arrangement procedure” is a rule in that the even if the order is the same, the function blocks need to be arranged in order from the closest ones to the input terminal with respect to the temporal order in arrangement for each row (R1, R2, R3, . . . ) using the block arrangement example in FIG. 28 by way of example.

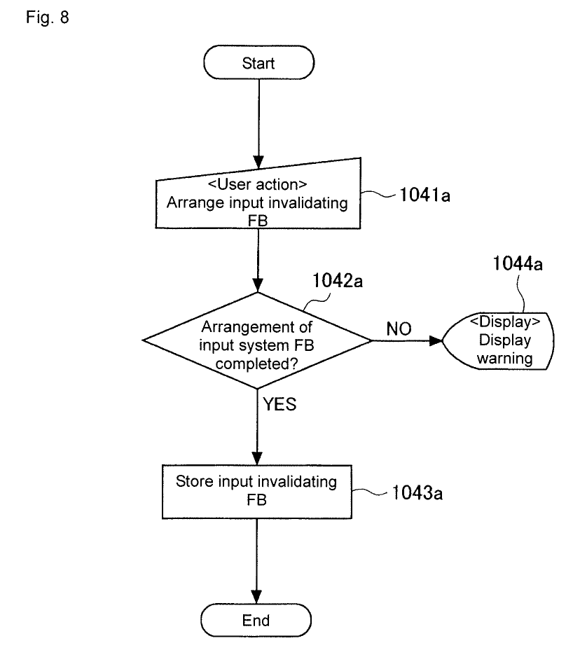

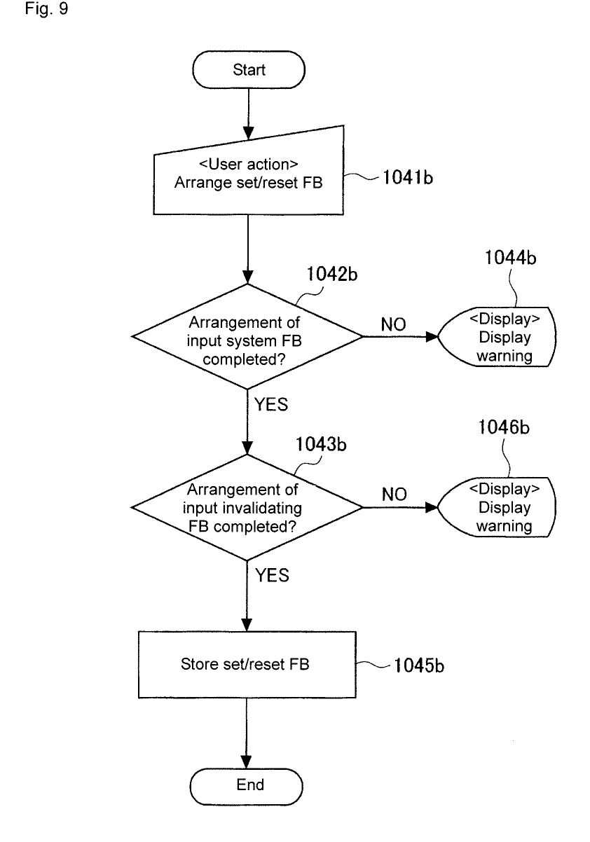

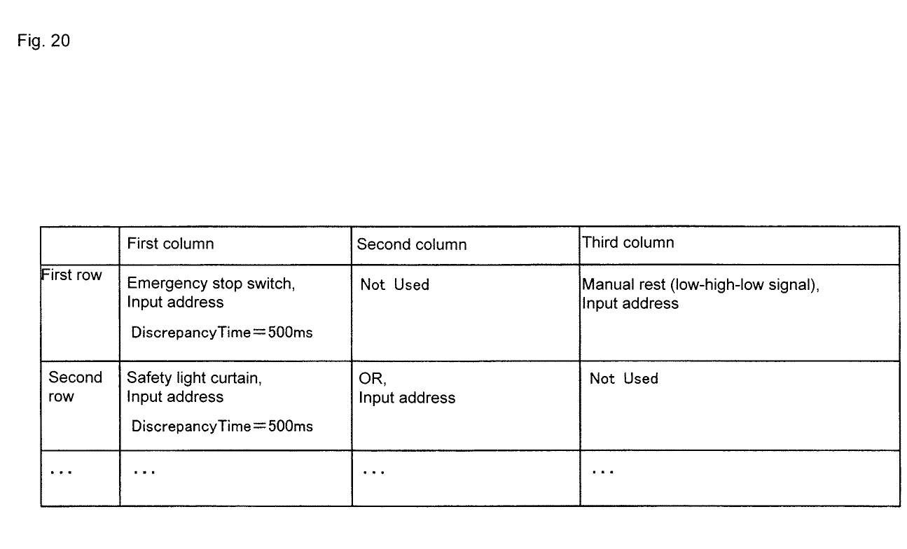

FIGS. 8 and 9 show an example of a process for leading each FB so as to be arranged according to the predefined “arrangement procedure”. Determination needs to be made on how the function blocks are currently arranged on the input side template to execute the processes. To this end, logic circuit data (10b) created by the user is stored in the work RAM 14 as shown in FIG. 20.

As shown in the figure, what function block is being currently arranged at each block arrangeable position specified by rows and columns is stored in the logic circuit data (10b). As hereinafter described, determination is made on whether or not attempt is made to arrange the FB according to the predefined “arrangement procedure” by referencing the logic circuit data (10b).

A determination process of the “arrangement procedure” in arranging the invalidating FB is shown in the flowchart of FIG. 8. As shown in the figure, if the FB to be arranged by the user action is the input invalidating FB, determination is made on whether or not the arrangement of the input system FB is already completed at the relevant point by referencing the logic circuit data (10b) shown in FIG. 20 for the “row” specified in the user action (step 1042a).

If the arrangement of the input system FB is already completed (YES in step 1042a), the input invalidating FB which arrangement is desired in the user action is stored in the memory as logic circuit data shown in FIG. 20 (step 1043a). On the contrary, if determined that the arrangement of the input system FB is not yet completed at the relevant point (step 1042a), a predetermined warning is displayed on the screen (step 1044a).

FIG. 9 shows a determination process of the “arrangement procedure” in a case of attempting to arrange the set/reset FB. As shown in the figure, if the FB which arrangement is desired by the user action is the set/reset FB, determination on whether or not the arrangement of the input system FB is completed is made (step 1042b), similar to the previous case. The process proceeds to step 1043b if determined that the arrangement of the input system FB is completed (YES in step 1042b), and a predetermined warning is displayed on the screen (step 1044b) if determined that the arrangement of the input system FB is not yet completed at the relevant point (NO in step 1042b).

If determined that the arrangement of the input system FB is completed (YES in step 1042b), determination is made on whether or not the arrangement of the input invalidating FB is completed (step 1043b).

If determined that the arrangement of the input invalidating FB is already completed (YES in step 1043b), the set/reset FB desired by the user action is stored (registered) to the corresponding block arrangeable position as shown in FIG. 20 (step 1045b). If the arrangement of the input system FB is completed (YES in step 1042b) but the arrangement of the input invalidating FB is not yet completed (step 1043b), a predetermined warning is displayed on the screen (step 1046b).

Therefore, in the input side circuit diagram data generating process (step 104) shown in FIG. 5, determination is made on whether or not the function block is being arranged according to the predefined “arrangement column” and the “arrangement procedure” every time the relevant function block is being arranged by the user action (step 104a), where the arrangement content of the desired FB is reflected on the logic circuit data (10b) only if the “arrangement column” and the “arrangement procedure” are both positive, and the arrangement of the FB is rejected and a predetermined warning is displayed on the screen if either the “arrangement column” or the “arrangement procedure” is determined as not the predefined column or the procedure (NO in step 104b).

In the embodiment described above, a menu method is used as a means for rejecting the function block of a type, other than the function block of the type determined in advance, from being arranged at the column of each template, but in place thereof, a series of function blocks to be selected may be arranged at one part of the display screen so that the function block can be moved to each column on the template through a drag-and-drop method of the mouse, where the type of the function block moved by the drag-and-drop method and the type of the function block assigned to its own row are checked on the side of each column, and if the types thereof do not match, similar forcible rejecting function can be realized by designing such that the function block cannot be dropped in the relevant column even if the drop operation is performed. In this case, the function block that has been moved or conveyed is returned to the original arrangement position at the moment the function block is dropped by the drag-and-drop operation, and may not be conveyed to the target column.

According to the input side circuit diagram data generating process performed under the support of the safety logic wizard, each function block is properly arranged on the input side template 202 with an appropriate “arrangement column”.

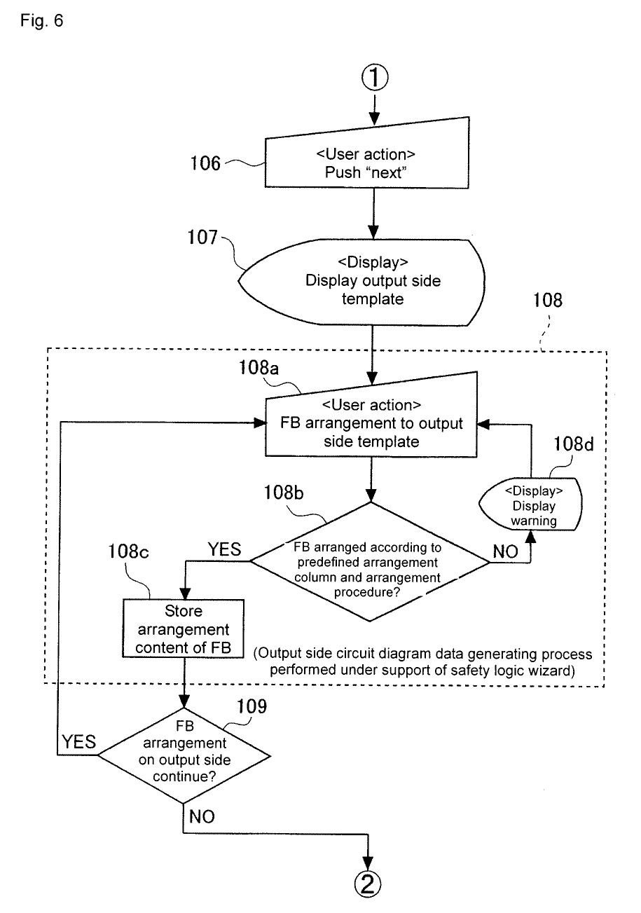

If all the desired function blocks are arranged on the input side template 202 (NO in step 105), the process proceeds to FIG. 6, and a user action (step 106) of operating the “Next” button D3 is waited to perform the processes related to the output side template.

In the processes related to the output side template, the output side template 210 incorporating the safety logic wizard is first displayed on the programming field 201 (step 107).

FIG. 29 shows an example of the output side template 210 displayed on the programming field 201 in the window 200. As described above, the output side template is defined with block arrangeable positions (region of horizontally long shape) so as to correspond to each intersecting point of the rows (R1, R2, R3, R4, . . . ) and the columns (C4, C5, C6), and flow of the output signal from the left side towards the right side in the row direction is defined.

Each column (C4, C5, C6) is assigned to the function block of a predetermined type related to the output signal. Specifically, in this example, the column (C4) positioned at the first stage is assigned to the output condition function block, the next column (C5) is assigned to the welding check (EDM) function block, and the next column (C6) is assigned to the terminal mode function block.

Returning back to FIG. 6, an output side circuit diagram data generating process (step 108) performed under the support of the safety logic wizard is executed following the display of the output side template (step 107).

The output side circuit diagram data generating process (step 108) is similar to the input side circuit diagram data generating process described above, and determination is made on whether or not the FB is arranged according to the predefined “arrangement column” and the “arrangement procedure” (step 108b) every time user action for FB arrangement to the output side template 210 is performed (step 108a), where if the determination is positive (YES in step 108b), a process (step 108c) of storing (registering) the arrangement content of the FB to be arranged in such manner is repeated as long as the FB arrangement on the output side is continued (YES in step 109). If the determination is negative (NO in step 108b), the arrangement of such FB is rejected, and a predetermined warning is displayed on the screen.

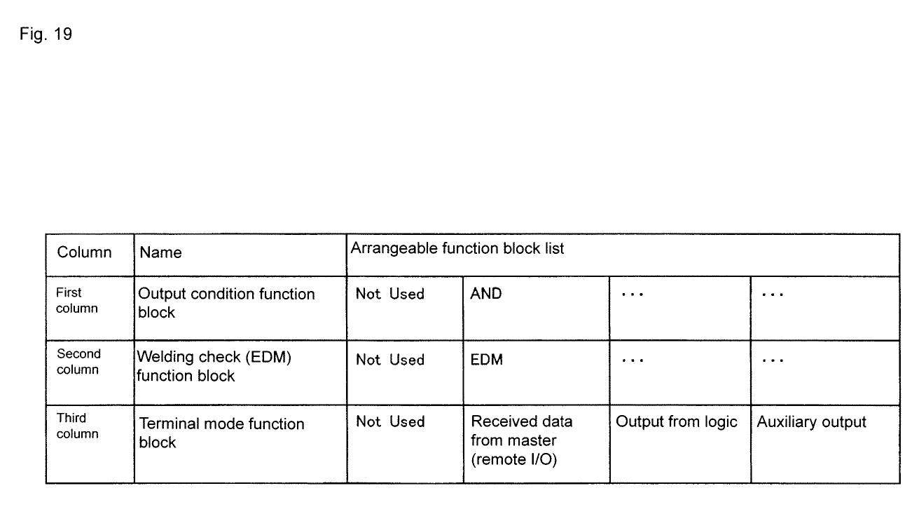

Determination on whether or not the FB is arranged according to the predefined “arrangement column” is made based on the content of the safety program template data (output side) shown in FIG. 19. That is, as shown in FIG. 19, the safety program template data (output side) is configured by storing, for every column, the type name of the function block allowed to be arranged in the relevant column and the list of specific function blocks included in the type name in association with each other.

In the illustrated example, reception data (remote I/O) from the master of the terminal mode function block of the third column refers to the output of the data received by the communication master from the remote I/O terminal (slave) when the safety controller is connected to the remote I/O terminal (slave) by way of the communication master unit. The output from the logic refers to the output of the operation result obtained by the logic operation inside the safety controller. An auxiliary output refers to the auxiliary output resulting from branching the output from the safety controller.

Every time some kind of user action for the FB arrangement on the output side template is detected (step 108a), the “block arrangeable position” specified by the user action and the “function block name” are checked with the safety program template data (output side) shown in FIG. 19 to determine whether or not the FB to be arranged is arranged according to the predefined “arrangement column”.

More specifically, assume a case of arranging the welding check (EDM) function block at the block arrangeable position specified by the row (R1) and the column (C5) on the premise of the output side template 210 shown in FIG. 29.

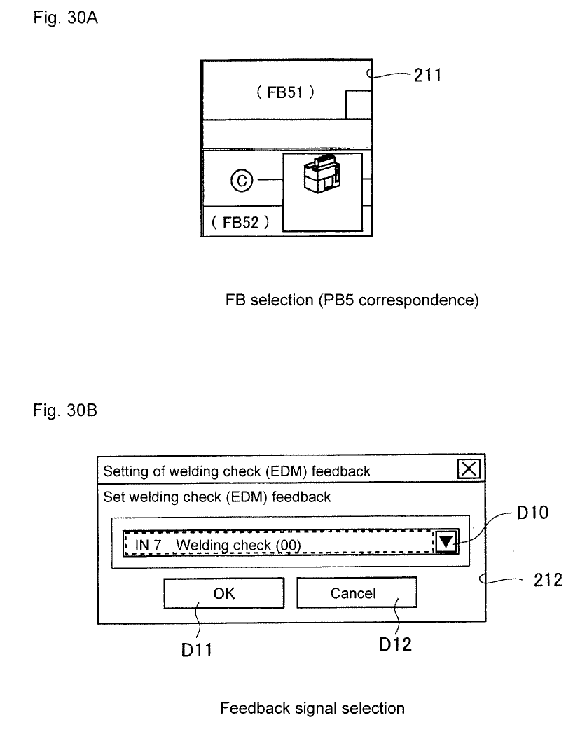

In such case, a pull-down button PB5 of the row (R1) is first operated with the mouse. A menu window 211 is then opened so as to overlap on the output side template 210, as shown in FIG. 30A. Two function blocks are vertically arranged over two stages in the menu window 211. That is, the function blocks are an output side branch function block FB 51 and an EDM function block FB52. The user selects the EDM function block (FB52) with the mouse operation. The selected function block (FB52) is arranged at the block arrangeable position specified by the row (R1) and the column (C5).

When setting the welding check (EDM) feedback on the EDM function block (FB52), a menu window 212 is opened as shown in FIG. 30B by a predetermined mouse operation. A pull-down button D10, an OK button D11, and a cancel button D12 are arranged in the menu window 212. The user operates the pull-down button D10 with the mouse in this state to display a feedback signal list, select a desired feedback signal therefrom, and operate the OK button D11 for establishing the setting of the welding check (EDM) feedback. In the example of FIG. 30B, an input signal IN7 is selected and set as the feedback signal.

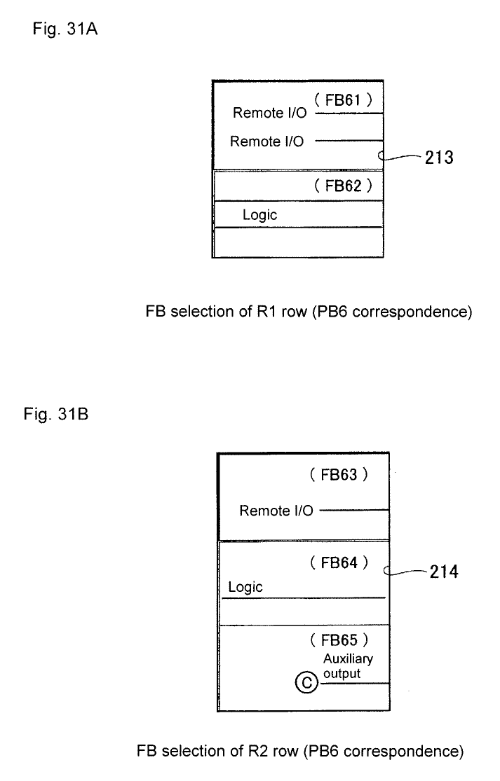

When arranging the duplication processed remote I/O function block at the block arrangeable position specified by the row (R1) and the column (C6), a pull-down button PB6 positioned on the right side of the block arrangeable position specified by the row (R1) and the column (C6) is operated with the mouse. A predetermined menu window 213 is then opened so as to overlap the output side template 210, as shown in FIG. 31A.

Two function blocks vertically arranged in two stages are displayed in the menu window 213. The function blocks are, in this example, duplication correspondence remote I/O function block (FB61) and non-duplication correspondence logic function block (FB62).

The user selects the duplication correspondence remote I/O function block (FB61) from the menu with the operation of the mouser. The selected function block (FB61) is then arranged at the block arrangeable position specified by the row (R1) and the column (C6).

Furthermore, when arranging the non-duplication correspondence logic function block (FB64) at the block arrangeable position specified by the row (R2) and the column (C6), the pull-down button PB6 positioned on the right side of the block arrangeable position is operated with the mouse. A menu window 214 is then opened so as to overlap the output side template 210, as shown in FIG. 31B.

Three function blocks are vertically displayed over three stages in the menu window 214. The function blocks are non-duplication correspondence remote I/O function block (FB63), the non-duplication correspondence logic function block (FB64), and the auxiliary output function block (FB65). The user then selects the non-duplication correspondence logic function block (FB64). The selected function block (FB64) is then arranged at the block arrangeable position specified by the row (R2) and the column (C6).

Similar to the case of the welding check (EDM) function block (FB52) shown in FIG. 30A, the selecting and the setting of the output condition function block are performed by the selecting and the setting using the menu window, and thus when further performing the setting of the output condition on the output condition function block thus selected and set as above, an excellent function taking usability of the user into consideration is provided in the present embodiment.

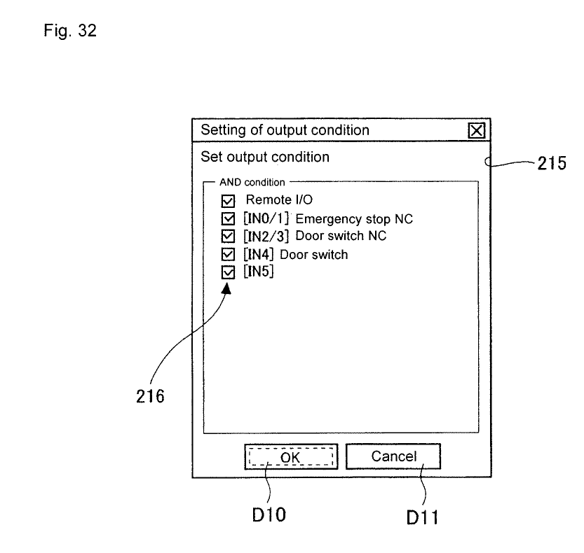

That is, as shown in FIG. 32, when setting the output condition for the selected and set output condition function block, an output condition setting window 215 is opened in response to a predetermined operation by the mouse. The input signal name to be the input candidate of the AND condition, which is the output condition, is displayed in series in the output condition setting window 215, and a check box 216 is arranged at the head of each input signal name. The selection of the input signal that becomes the output condition is carried out by simply inserting a predetermined check mark using the mouse in the check box 216. The OK button D13 is operated with the mouse to establish the selection, and the cancel button D14 is operated with the mouse to cancel the setting.

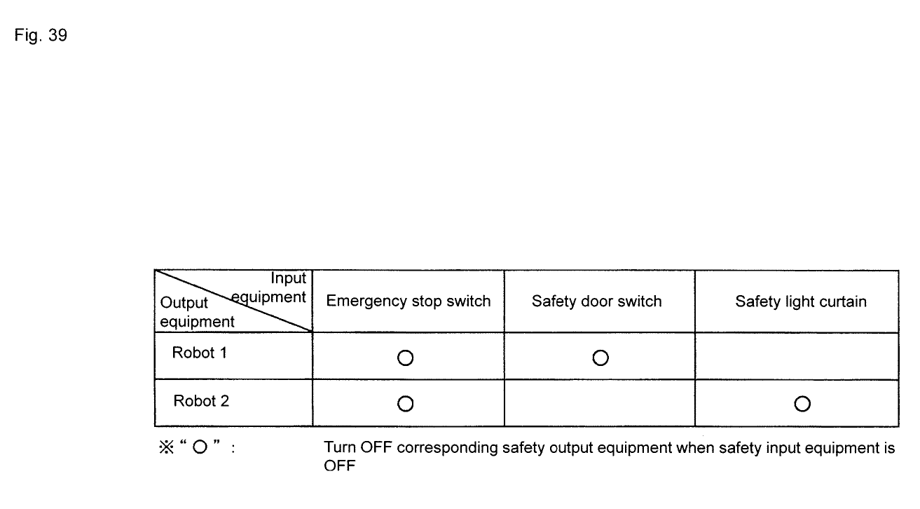

As described above, when performing this type of programming task, a safety input/output equipment correspondence table as shown in FIG. 39 is normally created beforehand, and the setting of the output condition is made relying on the safety input/output equipment correspondence table.

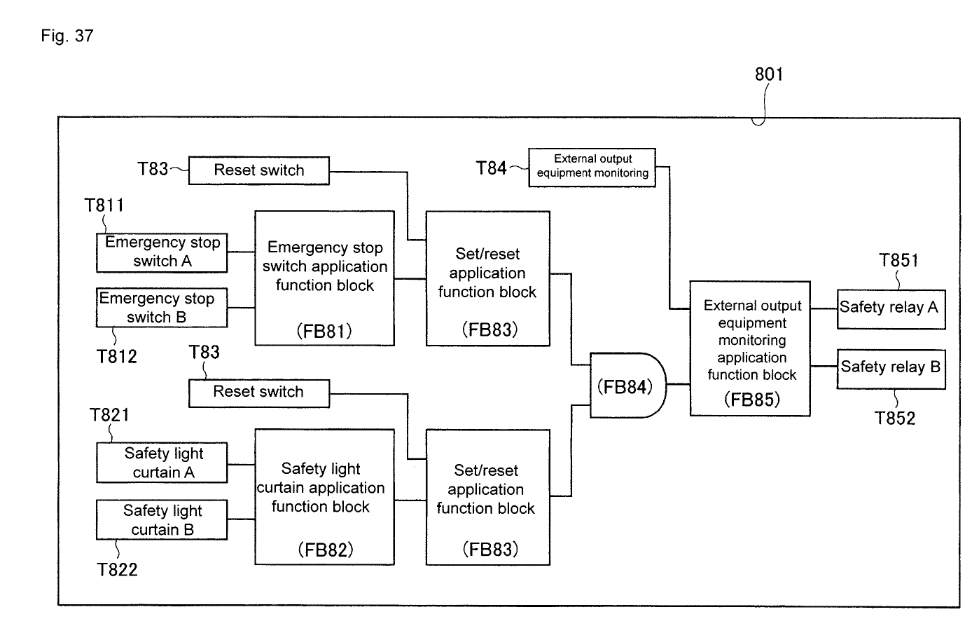

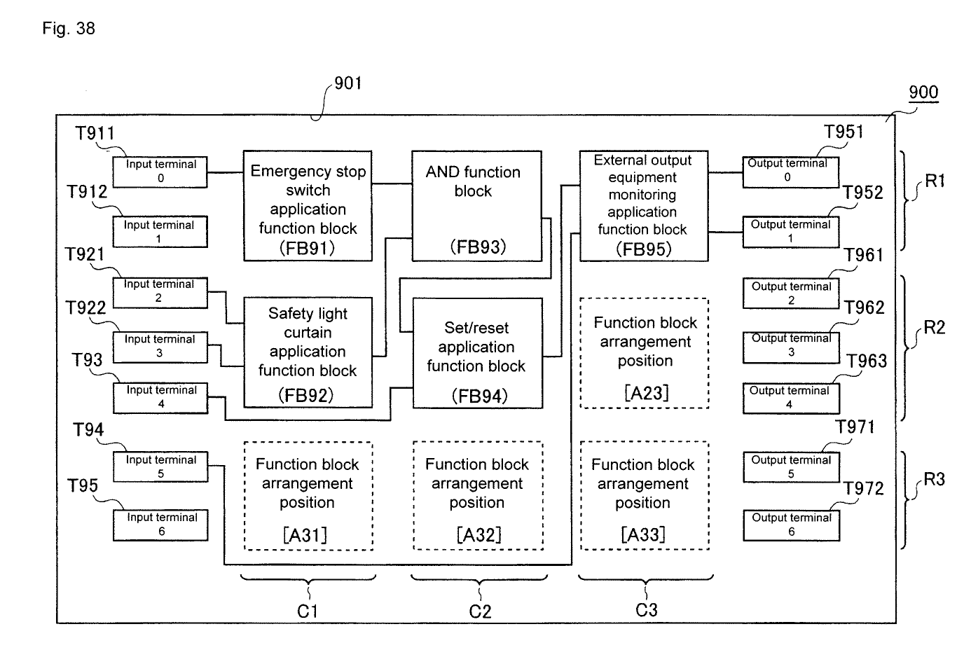

In a case of the conventional program development support apparatus shown in FIGS. 37 and 38, the setting of the output condition is made through the drawing operation of the wiring connecting the function blocks. Therefore, a troublesome task of checking the safety input/output correspondence table and the wiring diagram is required in verifying whether or not the output condition is correctly set.

In the present invention, on the other hand, the setting operation of the output condition defining the logic relationship of the input signal and the output signal includes selecting the corresponding input signal name from the series of input signal names displayed in the menu window 215 with the check operation of the check box, as shown in FIG. 32. Thus, in the setting of the output condition, the setting of the target output condition can be made with a simple operation by simply selecting the check box 216 as in the safety input/output equipment correspondence table shown in FIG. 39.

When verifying whether or not the output condition is correctly set in the completed program, the selected state of the check box in the menu window 215 and the input/output equipment correspondence table created in advance merely need to be checked, and the wiring between the function blocks does not need to be tracked back as in the related art example shown in FIGS. 37 and 38, whereby the verification task can be easily carried out in a short period of time.

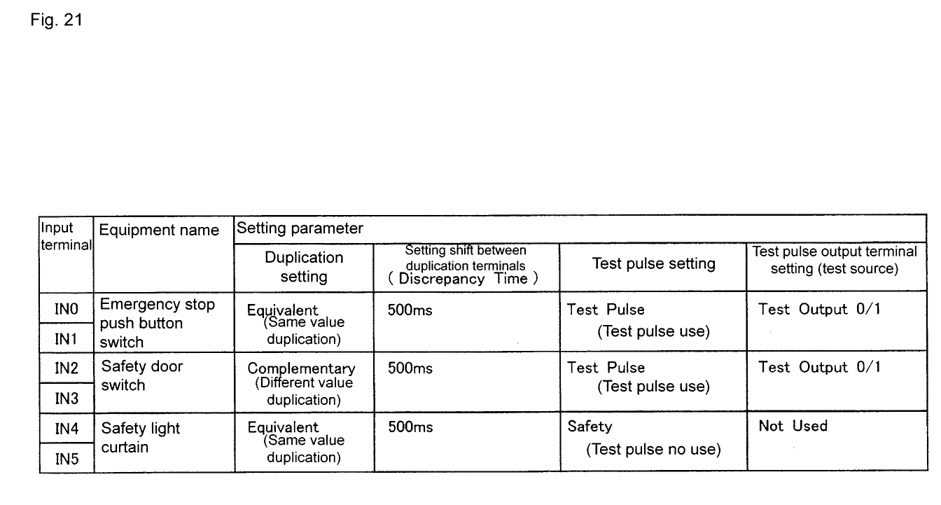

The data in the input equipment table shown in FIG. 21 is used for the data related to the input signal displayed in the menu window 215. The input equipment table is set by the setting operation of the input terminal, that is, normal operation performed to set the signal from which input equipment is to be input to the input terminal on the input side template 202 shown in FIG. 24. A special input information setting operation is unnecessary for the setting of the output condition.

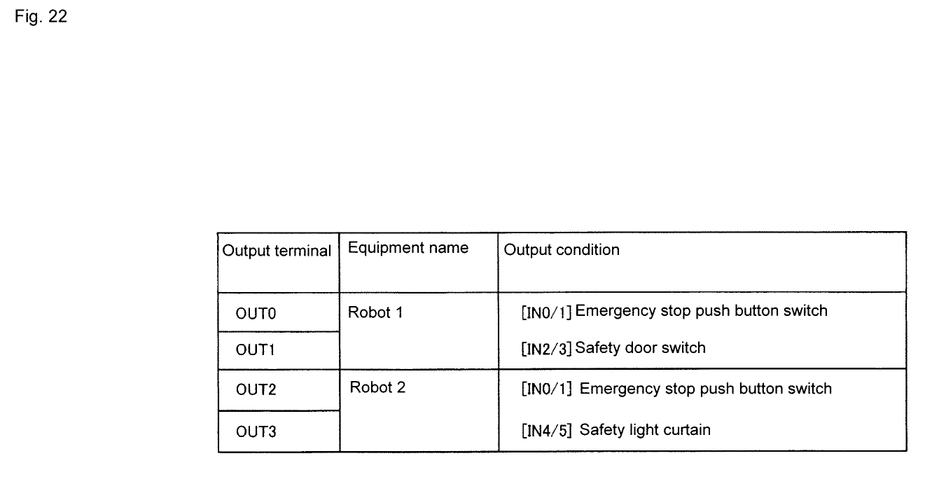

When the input signal name is selected through the selection of the mouse operation of the check box in the menu window 215, the safety output condition setting process shown in the flowchart of FIG. 17 is activated. Accordingly, the output condition setting table is completed as shown in FIG. 22. The safety output condition setting process shown in FIG. 17 is executed in the output circuit diagram data generating process 108 performed under the support of the safety logic wizard described above.

That is, as shown in the flowchart of FIG. 17, when the user action for the setting selection of the safety output condition is performed (step 1071), the safety input equipment is searched and extracted from the input equipment table (see FIG. 21) (step 1072), and a list of input signals in the menu window 215 shown in FIG. 32 is displayed based on the extracted input equipment data. The safety input terminal number, the equipment name, and the like are displayed in a check box format as a safety output condition selection screen display (step 1073).

When the user action of checking the check box 216 to select the corresponding safety output condition and pushing the “OK” button for confirmation is performed in this state (step 1074), the safety output condition selected in this manner is stored (step 1075), which process is repeated over necessary number of times (YES in step 1076), and the output condition setting table shown in FIG. 22 is completed.

FIG. 28 shows the state of the output side template arranged with the terminal mode FB, the output condition FB, and the welding check FB. As apparent from the figure, it can be recognized that the selected function blocks (FB62, FB65, FB52, FB41) are respectively arranged at each specified block arrangeable positions by the above described selecting and setting process.

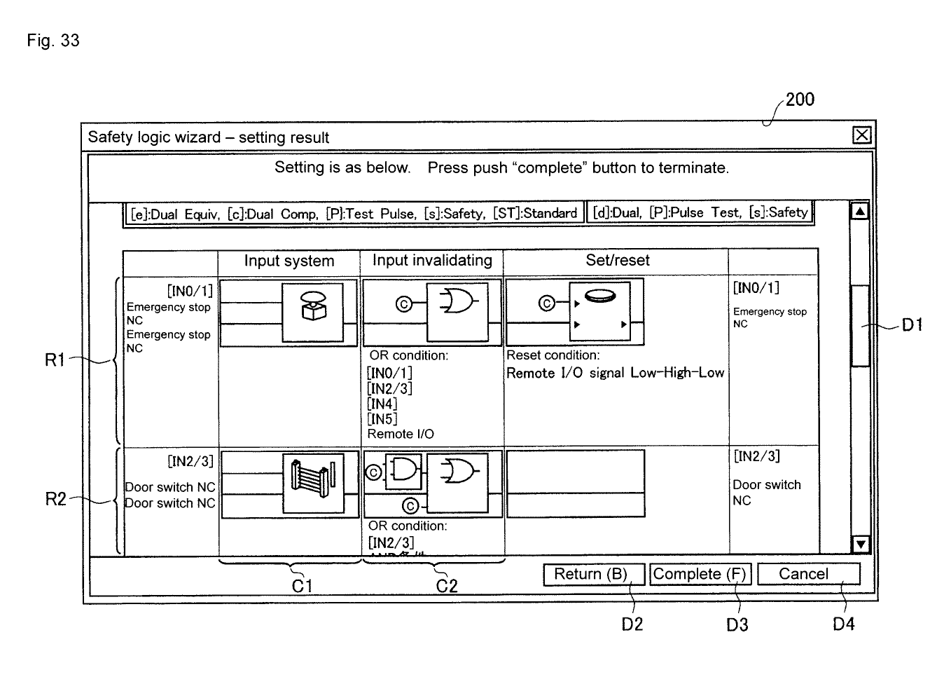

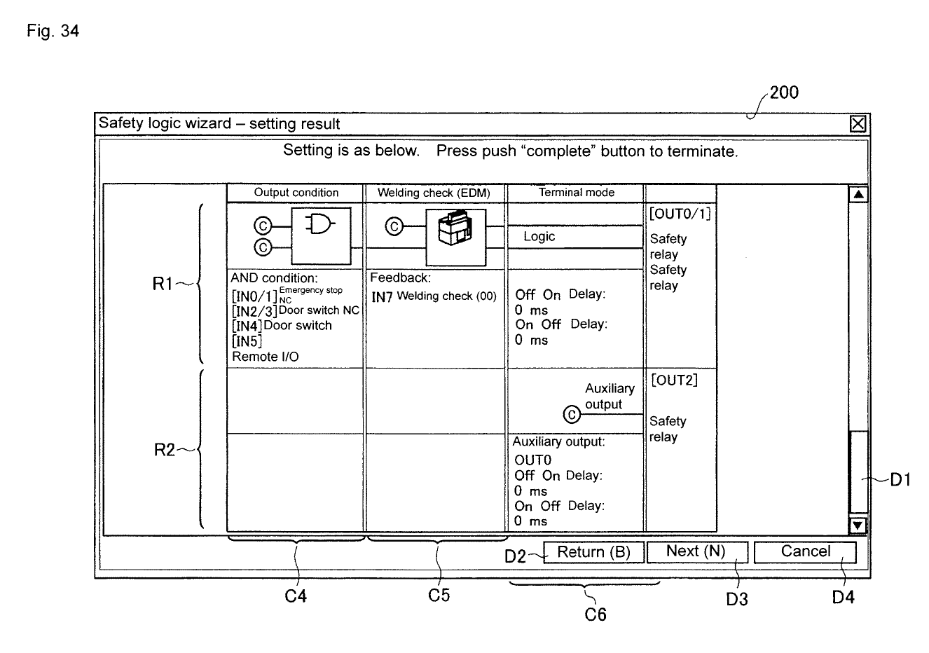

Lastly, FIG. 33 shows an explanatory view of a check screen at the completion of the FB arrangement on the input side template, and FIG. 34 shows an explanatory view of a check screen at the completion of the FB arrangement on the output side template.

As apparent from such figures, the necessary function blocks are appropriately arranged at the necessary positions on the input side template and the output side template by repeating the function block selecting and setting operation described above.

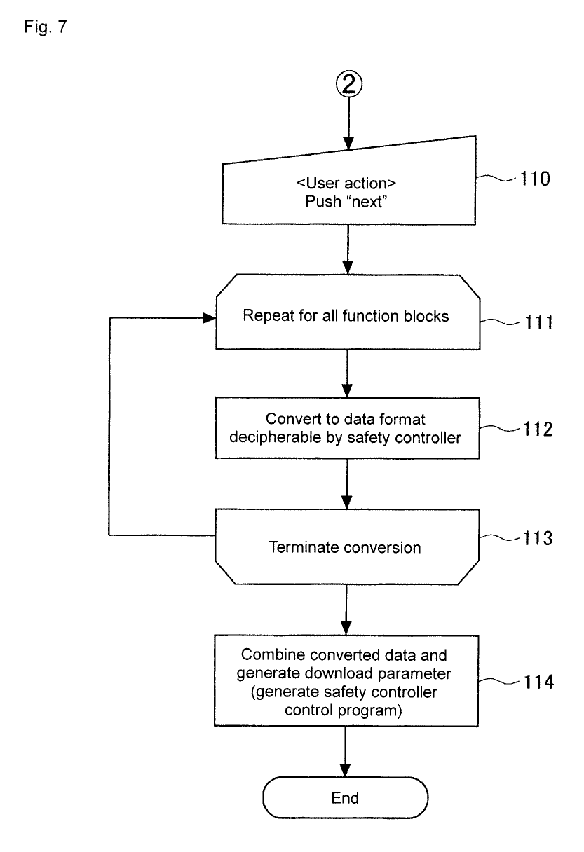

When a predetermined complete button is operated in this state, the created circuit diagram is confirmed, the data conversion process (steps 111 to 113) and the download parameter generating process (step 114) previously described with reference to FIG. 7 are executed, and the safety controller control program is ultimately generated.

In the output side circuit diagram data generating process (step 108) shown in the flowchart of FIG. 6, determination is made on whether or not the FB is arranged according to the predefined “arrangement column”, where the arrangement content of the FB which arrangement is desired is stored (registered), and the logic circuit data (10b) shown in FIG. 20 is generated only when determined that the FB is arranged according to the predefined “arrangement column” (YES in step 108b).

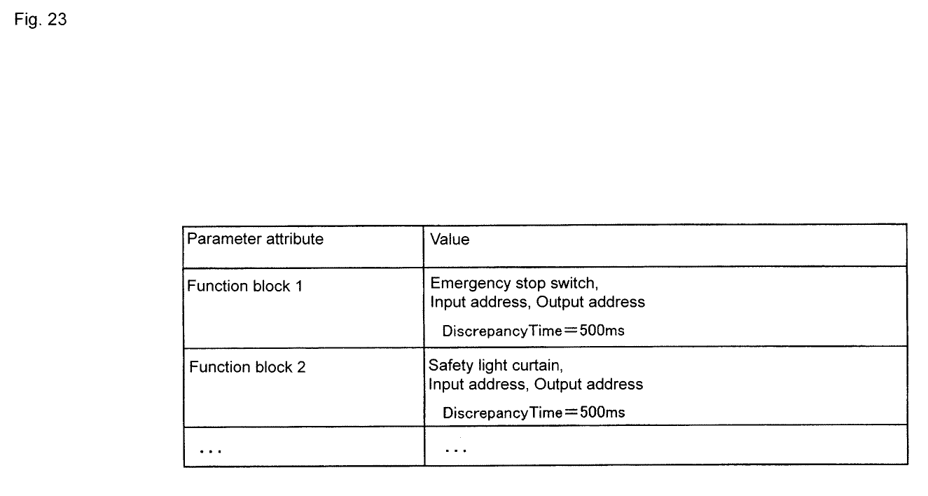

Returning back to FIG. 7, after the arrangement of the necessary function blocks on the output side template 210 is completed, the user action corresponding to the operation of the “Next” button D3 is waited (step 110). The logic circuit data (10b) shown in FIG. 23 generated in the above described function block arrangement operation is then converted to a data format decipherable by the safety controller with respect to all the function blocks (steps 111 to 113). Therefore, the converted data is collected to generate the download parameter (safety controller control program) (step 114).

The download parameter generated in this manner is installed in the target safety controller through communication or through portable recording medium similar to the related art.

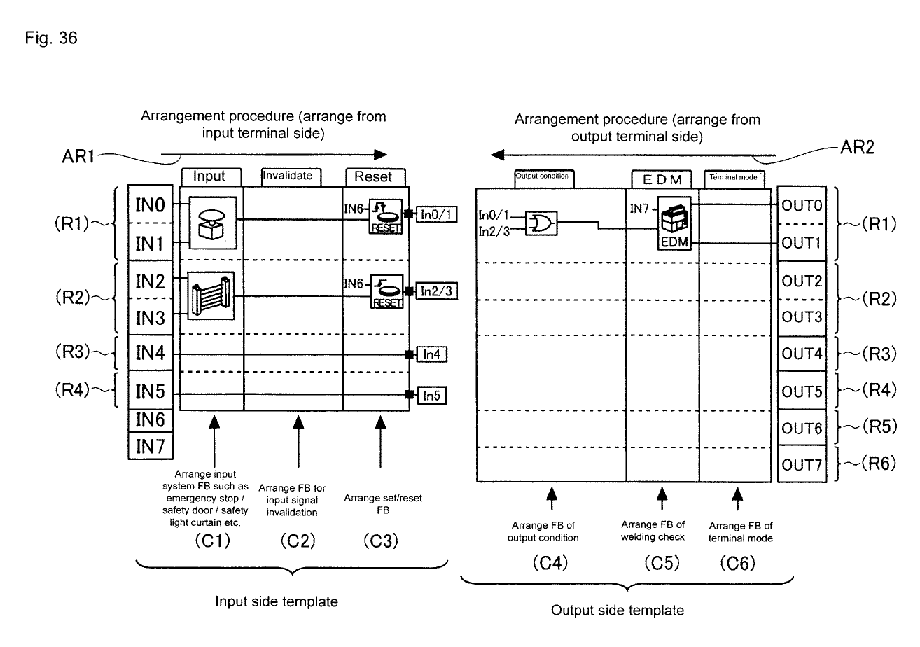

Therefore, according to the program development support apparatus of each embodiment described above, the signal path related to the same signal exists in the same row in each template since the entire template is separated into the input side template and the output side template, as shown in FIG. 36.

In each column (C1 to C6) of each template, the function blocks of the same type are guided to be arranged by the operation of the safety logic wizard. Furthermore, the function blocks of the same type are automatically arrayed in the same column by the operation of the safety logic wizard, and thus even if any one of the function block is forgotten to be arranged, the presence of the function blocks is checked by columns after the program is completed, and the relevant portion is intensively checked if the function block does not exist in any one of the rows, so that debugging of this type of safety controller control program can be easily performed.

According to the structure of such input side template or the output side template, the programming mistake of mistakenly arranging the function block to be arranged in the same signal path in a different signal path, or arranging the function block to be arranged on the input signal path on the output signal path is reliably prevented by simply habitually arranging the function block related to the same signal in the same row.

Not limited to simply separating the template into two templates, the input side template may be presented to the user before the output side template, so that the arrangement of the function block on the input side template is already completed at the stage of arranging the function block on the output side template, whereby the programming mistake by the user can be prevented in advance.

As shown in FIG. 32, the setting of the output condition is made based on the list of input signals in check box format, and thus direct check with the safety input/output equipment correspondence table can be made unlike the program development support apparatus in wiring diagram format of the related art, which contributes to simplification of the programming task as well as the program verification task.

What is claimed is:

1. A program development support apparatus of a safety controller in which a control program for the safety controller is automatically generated through a series of user operations for completing a logic circuit diagram corresponding to a desired control specification by sequentially arranging one type of function block selected from a plurality of types of function blocks prepared in advance in a programming field on a screen of an image display and setting a necessary unique parameter for every function block; the program development support apparatus comprising:
an input operation unit for enabling said series of user operations; and
a guide display unit, displayed on the programming field, for enabling arrangement of the function block to the programming field according to a guide by a function block arrangement template having a block arrangeable position corresponding to each intersecting position of rows and columns, and having one end side in the row direction defined as an input terminal side and the other end side defined as an output terminal side; wherein
the function block arrangement template is separated into,
an input side template positioned on an input side of the template and including a series of plural columns respectively accepting the arrangement of a predetermined type of function block related to an input signal, and
an output side template positioned on an output side of the template and including a series of plural columns respectively accepting the arrangement of a predetermined type of function block related to an output signal.

2. The program development support apparatus according to claim 1, wherein the guide display unit alternately display the input side template and the output side template on the programming field.

3. The program development support apparatus according to claim 2, wherein the guide display unit displays on the programming field such that the input side template is first displayed, and the output side template is subsequently displayed.

4. The program development support apparatus according to claim 1, wherein the guide display unit further includes a leading unit for leading each function block to an arrangement column defined in advance according to an arrangement procedure defined in advance so that a function block selected by a user is arranged at the block arrangeable position of a corresponding column on each template according to the arrangement column and the arrangement procedure defined in advance for each type.

5. The program development support apparatus according to claim 4, wherein the leading unit is a guide display for allowing the user to perform necessary operations.

6. The program development support apparatus according to claim 4, wherein the leading unit detects an operation in which the function block selected by the user is arranged on each template according to the arrangement column other than the arrangement column defined in advance for every type or the arrangement procedure other than the arrangement procedure defined in advance and prohibits the operation, or detects the operation to issue a warning thereto.

7. The program development support apparatus according to claim 4, wherein the leading unit forcibly rejects the arrangement of a function block other than the function block scheduled to be arranged in the corresponding column.

8. The program development support apparatus according to claim 4, wherein the arrangement procedure defined in advance in a case where the template is the input side template is to arrange each function block in order from the column close to the input terminal side.

9. The program development support apparatus according to claim 4, wherein the arrangement procedure defined in advance in a case where the template is the output side template is to arrange each function block in order from the column close to the output terminal side.

10. The program development support apparatus according to claim 1, wherein a setting on a correspondence relationship between at least an input terminal and an input equipment input to the input terminal is required for every function block when arranging each function block on the input side template, the set correspondence relationship being recorded in a storage medium of the apparatus as an input equipment table when the setting is completed on the input side template;
a setting of an input signal is required at least as a unique parameter at an output condition function block, which is one of the function blocks, when arranging each function block on the output side template; and
an input signal setting unit for enabling an operation of selecting a desired input signal from a menu displayed input signal list by referencing the input equipment table when setting the input signal is further arranged.

11. The program development support apparatus according to claim 10, wherein the menu display of the input signal list is performed by arraying input signal names to be set within a menu window opened on the screen of the image display.
